(19) United States
(12) Patent Application Publication
(10) Pub. No.: US 2002/0013687 A1
(43) Pub. Date: Jan. 31, 2002

(54) Methods and systems for simulation-enhanced fracture detections in sedimentary basins

(76) Inventor: Peter J. Ortoleva, Bloomington, IN (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/818,752

(22) Filed: Mar. 27, 2001

Related U.S. Application Data
(60) Provisional application No. 60/192,190, filed on Mar. 27, 2000.

(51) Int. Cl. G06G 7/48

(52) U.S. Cl. 703/10

(57) ABSTRACT

A three-dimensional, geologic basin simulator for predicting natural resource location and characteristics is disclosed. The simulator integrates seismic inversion techniques with other data to predict fracture location and characteristics. The invention's 3-D finite element basin reaction, transport, mechanical simulator includes a rock rheology that integrates continuous deformation (poroelastic/viscoplastic) with fracture, fault, gouge, and pressure solution. Mechanical processes are used to coevolve deformation with multi-phase flow, petroleum generation, mineral reactions, and heat transfer to predict the location and producibility of fracture sweetspots. The simulator uses these physico-chemical predictions to integrate well log, surface, and core data with the otherwise incomplete seismic data. The simulator delineates the effects of regional tectonics, petroleum-derived overpressure, and salt tectonics and constructs maps of high-grading zones of fracture producibility.

### CROSS-REFERENCE TO RELATED APPLICATIONS

The present application claims the benefit of U.S. application Ser. No. 60/192,190, filed on Mar. 27, 2000, which is hereby incorporated in its entirety by reference.

### TECHNICAL FIELD

The present invention relates generally to three-dimensional modeling, and, more particularly, to modeling fractures in sedimentary basins in the context of resource exploration and production.

### BACKGROUND OF THE INVENTION

Interest in the remote detection of fractures in tight geologic reservoirs has grown naturally as new discoveries of petroleum and natural gas from conventional reservoirs have declined. The trend in remote detection is to invert seismic data. The problem is that such an inversion may not be possible in principle. For example, in an azimuthally anisotropic medium, the principal directions of azimuthal anisotropy are the directions along which the compressional and shear waves propagate. If anisotropy is due solely to fractures, anisotropy data can be used to study dominant fracture orientations. However, observed rose diagrams show that in most cases a fracture network consists of many intersecting fracture orientations.

A complete exploration and production (E&P) characterization of a fractured reservoir requires a large number of descriptive variables (fracture density, length, aperture, orientation, and connectivity). However, remote detection techniques are currently limited to the prediction of a small number of variables. Some techniques use amplitude variation with offsets to predict fracture orientations. Others delineate zones of large Poisson's ratio contrasts which correspond to high fracture densities. Neural networks have been used to predict fracture density. Porosity distribution may be predicted through the inversion of multicomponent three-dimensional (3-D) seismic data. These predictive techniques are currently at best limited to a few fracture network properties. Most importantly, these results only hold if the medium is simpler than a typical reservoir. For example, they may work if there is one fracture orientation and no inherent anisotropy due to sediment lamination or other inhomogeneity and anisotropy.

Difficulties with remote fracture detection come from the many factors affecting mechanical wave speed and attenuation including:

porosity and texture of unfractured rock;

density and phases of pore- and fracture-filling fluids;

fracture length and aperture statistics and connectivity;

fracture orientation relative to the propagation direction;

fracture cement infilling volume, mineralogy, and texture;

pressure and temperature; and

gouge layers.

These variables cannot be extracted from the speed and attenuation of reflected or transmitted seismic waves, even when the various polarizations and shear vs. compression components are separately monitored. Thus, direct remote detection cannot provide enough information to unambiguously identify and characterize fracture sweetspots.

The petroleum industry requires information about the producibility of fracture networks: cement infilling; geometry, connectivity, density, and preferred orientation as well as parameters for dual porosity/dual permeability reservoir models; stress and reservoir sensitivity to pressure drawdown; petroleum content of the matrix; and fractures. While desirable for optimal exploration and petroleum field development, this level of detailed characterization is far beyond available remote detection methodologies.

### SUMMARY OF THE INVENTION

The above problems and shortcomings, and others, are addressed by the present invention, which can be understood by referring to the specification, drawings, and claims. The present invention is a 3-D basin simulator that integrates seismic inversion techniques with other data to predict fracture location and characteristics. The invention's 3-D finite element basin reaction, transport, mechanical simulator includes a rock rheology that integrates continuous deformation (poroelastic/viscoplastic) with fracture, fault, gouge, and pressure solutions. Mechanical processes are used to coevolve deformation with multi-phase flow, petroleum generation, mineral reactions, and heat transfer to predict the location and producibility of fracture sweet spots. The simulator uses these physico-chemical predictions to integrate well log, surface, and core data with the otherwise incomplete seismic data. The simulator delineates the effects of regional tectonics, petroleum-derived overpressure, and salt tectonics and constructs maps of high-grading zones of fracture producibility.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a depiction of the Simulation-Enhanced Fracture Detection approach;

FIG. 2 is a table of the “laboratory” basins for use in reaction, transport, mechanical model testing;

FIG. 3 shows the coupled processes underlying the dynamics of a sedimentary basin;

FIG. 4a depicts the fracture healing cycle;

FIG. 4b show the Ellenburger overpressure oscillation;

FIG. 5 is a simulation from the Piceance Basin;

FIGS. 6a, 6b, and 6c show predictions from the Piceance Basin;

FIG. 7 shows predicted rose diagrams for the Piceance Basin;

FIGS. 8a and 8b are simulations of the Piceance Basin;

FIGS. 9a and 9b are normal fault simulations;

FIG. 10 shows an oil saturation/salt dome;

FIG. 11 is a simulation of subsalt oil;

FIG. 12 is a simulation of a salt diapir;

FIG. 13 is a flow chart of a basin reaction, transport, mechanical model;

FIGS. 14a and 14b show a prediction of Andector Field fractures;

FIG. 15 is a table of input data available for the Illinois Basin;

FIG. 16 shows a simulation of the Illinois Basin;

FIG. 17 shows the 3-D stratigraphy of the Illinois Basin;

FIG. 18 is a map of the Texas Gulf coastal plain;

FIG. 19 is a map of producing and explored wells along the Austin Chalk trend;

FIG. 20 is a generalized cross-section through the East Texas Basin;

FIG. 21 is a schematic depiction of a data/modeling integration approach;

FIG. 22 is a cross-section and two 3-D views of the Anadarko Basin;

FIG. 23 shows a Basin RTM simulation of normal faulting;

FIG. 24 is a tectonic Anadarko Basin map showing major structures;

FIG. 25 shows a simulation of Piceance Basin overpressure, dissolved gas, and gas saturation;

FIG. 26 lists references to theoretical and experimental relations between log tool response and fluid/rock state;

FIG. 27 is a Basin RTM-simulated sonic log and error used to identify basement heat flux;

FIG. 28 shows a simulation of lignin structural changes at the multi-well experiment site, Piceance Basin;

FIG. 29 shows a zone of high permeability and reservoir risk determined using information theory;

FIG. 30 lists Anadarko Basin data;

FIG. 31 is the Hunton Formation topography automatically constructed from well data;

FIG. 32 is a time-lapse crosswell seismic result from Section 36 of the Vacuum Field;

FIG. 33 shows a cross-section of a tortuous path showing various transport phenomena and a pore throat flow-blocking bubble/globule inhibiting the flow of non-wetting phases;

FIG. 34 is a flowchart of a computational algorithm used in a simulation-enhanced seismic image interpretation method;

FIG. 35 presents preliminary results of a phase geometry dynamics model showing fronts of evolving saturation and wetting;

FIG. 36 compares two synthetic seismic signals created from Basin RTM predicted data with two different assumed geothermal gradients;

FIG. 37 is a result using the crosswell tomographic image interpretation approach to determine basin evolution parameters;

FIG. 38 shows how the Simulation-Enhanced Remote Geophysics (SERG) software automatically constructs the most probable state of the reservoir at scales of spatial resolution consistent with that implied be the upscaling in the reservoir simulator used or the resolution of the available data;

FIG. 39 shows a 2-D SERG test domain;

FIGS. 40a through 40c illustrate a cross-section view of an upper and lower reservoir separated by a seal with a puncture;

FIG. 41 is a preliminary prediction of the initial data from information at selected wells;

FIG. 42 shows how the present iterative method works in 3-D;

FIG. 43 is a plot of the dependence of the error in the predicted vs. observed seismic signal as a function of the geothermal gradient taken to operate during basin evolution;

FIG. 44 is a map of the major onshore basins of the contiguous United States;

FIG. 45 is a schematic view of cases wherein a reservoir is segmented or contains super-K (anomalously high permeability);

FIG. 46 is a flow chart showing how a reservoir simulator or a complex of basin and reservoir simulators are used to integrate, interpret, and analyze data;

FIG. 47 portrays a Simulator Complex showing simulator relationships;

FIG. 48 is a permeability distribution constructed by FDM (field development and management) technology;

FIG. 49 shows FDM-predicted, initial data from transient production history of a number of wells;

FIG. 50 is a map of the Permian Basin in New Mexico, used as a demonstration site;

FIG. 51 shows how the present reservoir and basin simulator uniquely captures the full suite of RTM processes and the coupling among them; and

FIG. 52 is a graph showing that the probability of variations on a length scale 2π/k becomes independent of k as k approaches infinity.

### DETAILED DESCRIPTION OF THE INVENTION

Turning to the drawings, the invention is illustrated as being implemented in a suitable environment. The following description is based on embodiments of the invention and should not be taken as limiting the invention with regard to alternative embodiments that are not explicitly described herein.

### Technical Overview of Simulation-Enhanced Fracture Detection

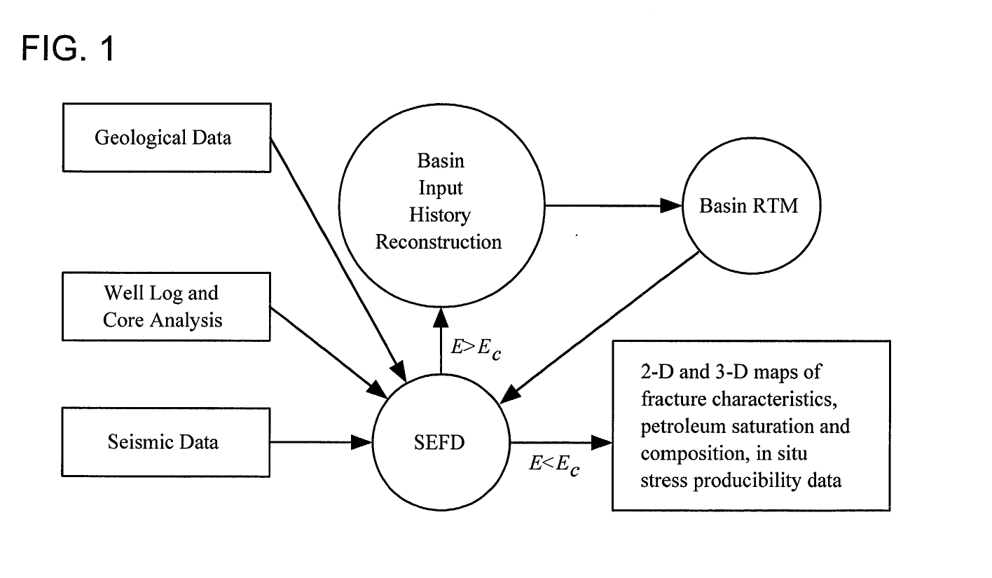

The present invention enhances seismic methods by using a 3-D reaction, transport, mechanical (RTM) model called Basin RTM. Remote observations provide a constraint on the modeling and, when the RTM modeling predictions are consistent with observed values, the richness of the RTM predictions provides detailed data needed to identify and characterize fracture sweetspots (reservoirs). This simulation-enhanced fracture detection (SEFD) scheme is depicted in FIG. 1. SEFD makes the integration of remote measurement and other observations with modeling both efficient and “seamless.”

The SEFD algorithm has options for using raw or interpreted seismic data. The output of a 3-D basin simulator, Basin RTM, is lithologic information and other data used as input to a synthetic seismic program. The latter's predicted seismic signal, when compared with the raw data, is used as the error measure E as shown in FIG. 1. Similarly, well logs and other raw or interpreted data shown in FIG. 1 can be used. The error is minimized by varying the least well-constrained basin parameters.

The SEFD method integrates seismic data with other E&P data (e.g., well logs, geochemical analysis, core characterization, structural studies, and thermal data). Integration of the data is attained using the laws of physics and chemistry underlying the basin model used in the SEFD procedure:

conservation of momentum (rock deformation, fluid flow);

conservation of mass (fluid species and phases, and mineral reactions and transport); and

conservation of energy (heat transfer and temperature).

These laws facilitate extrapolation away from the surface and wellbore and are made consistent with seismic data to arrive at the SEFD approach shown in FIG. 1.

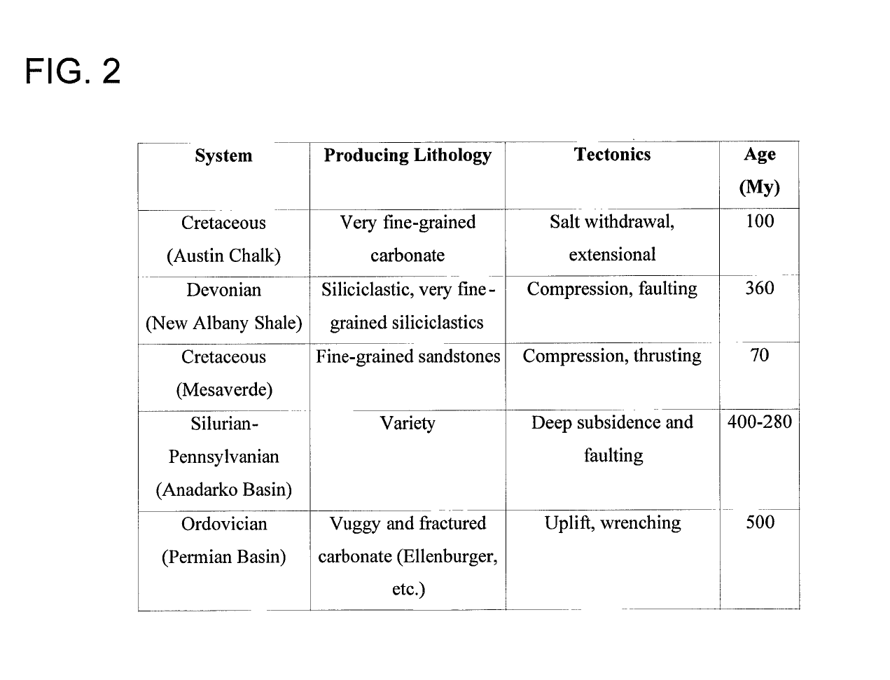

The SEFD model is calibrated by comparing its predictions with observed data from chosen sites. Calibration sites meet these criteria: sufficient potential for future producible petroleum, richness of the data set, and diversity of tectonic setting and lithologies (mineralogy, grain size, matrix porosity). FIG. 2 lists several sites for which extensive data sets have been gathered.

Basin RTM attains seismic invertibility by its use of many key fracture prediction features not found in previous basin models:

nonlinear poroelasticity/viscosity rheology with integrated pressure solution, fracture strain rates, and yield behavior for faulting;

a full 3-D fracture network statistical dynamics model;

rheologic and multi-phase parameters that coevolve with diagenesis, compaction, and fracturing;

new multi-phase flow and kerogen reactions producing petroleum and affecting overpressure;

tensorial permeability from preferred fracture orientation and consequent directed flows;

inorganic fluid and mineral reactions and organic reactions; and

heat transfer.

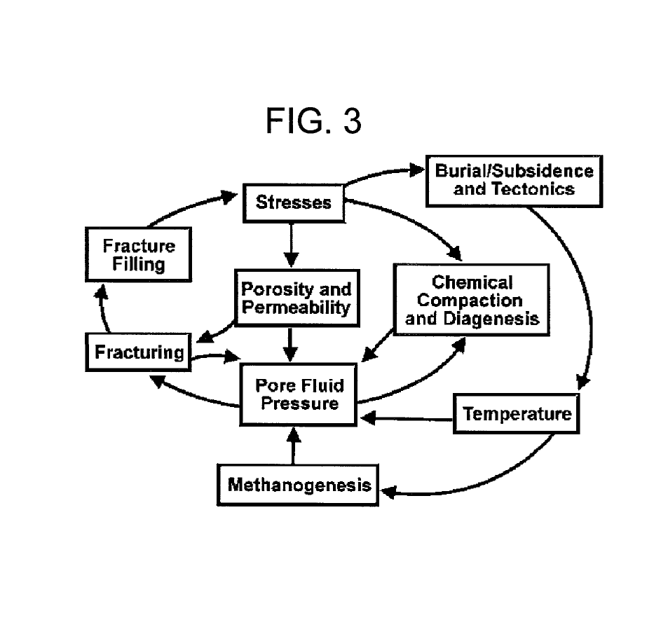

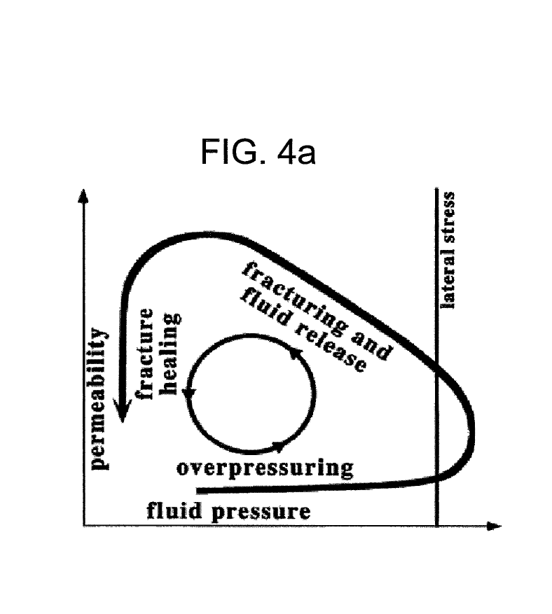

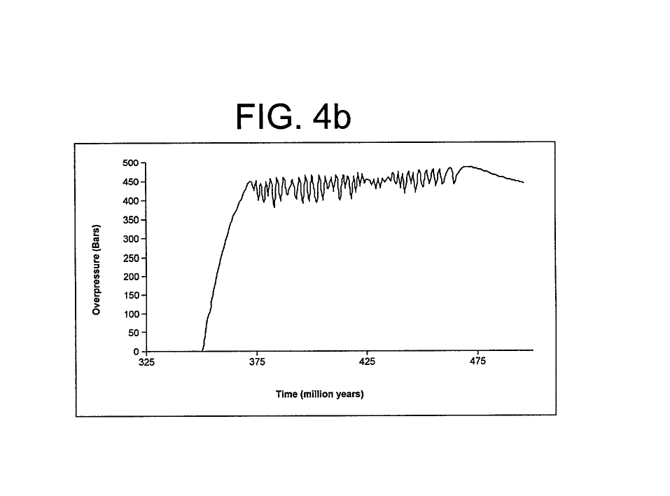

While previous models have some of these processes, none have all, and none are implemented using full 3-D finite element methods. Basin RTM preserves all couplings between the processes shown in FIG. 3. The coupling of these processes in nature implies that to model any one of them requires simulating all of them simultaneously. As fracturing couples to many RTM processes, previous models with only a few such factors cannot yield reliable fracture predictions. In contrast, the predictive power of Basin RTM, illustrated in FIGS. 4 through 9 and discussed further below, surmounts these limitations.

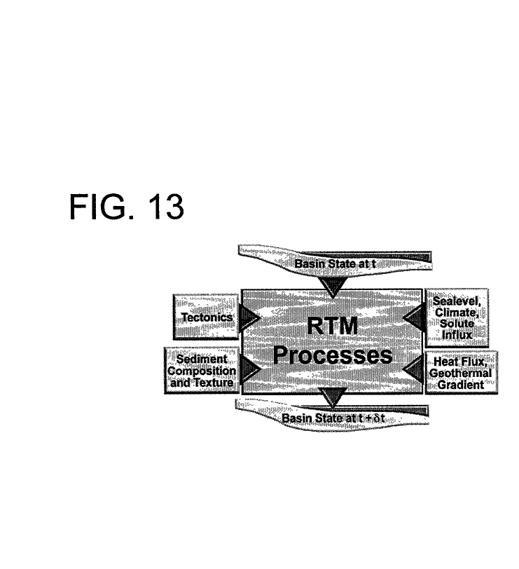

Commonly observed “paradoxes” include fractures without flexure and flexure without fractures. These paradoxes illustrate the inadequacy of previous fracture detection techniques based on statistical correlations. For example, previous models base porosity history on a formula relating porosity to mineralogy and depth of burial. However, porosity evolves due to the detailed stress, fluid composition and pressure, and thermal histories of a given volume element of rock. These histories are different for every basin. Thus, in the real world, there is no simple correlation of porosity with depth and lithologic type. As shown in FIG. 3, aspects of geological systems involve a multiplicity of factors controlling their evolution. Some processes are memory-preserving and some are memory-destroying. There are no simple correlations among today's state variables. The detailed history of processes that operated millions of years ago determines today's fracture systems. Basin RTM avoids these problems by solving the fully coupled rock deformation, fluid and mineral reactions, fluid transport and temperature problems (FIGS. 3 and 13). Basin RTM derives its predictive power from its basis in the physical and chemical laws that govern the behavior of geological materials.

As salt withdrawal is an important factor in fracturing in some basins, Basin RTM models salt tectonics. Basin RTM addresses the following E&P challenges:

predict the location and geometry of zones of fracturing created by salt motion;

predict the morphology of sedimentary bodies created by salt deformation;

locate pools of petroleum or migration pathways created by salt tectonics; and

assist in the interpretation of seismic data in salt tectonic regimes.

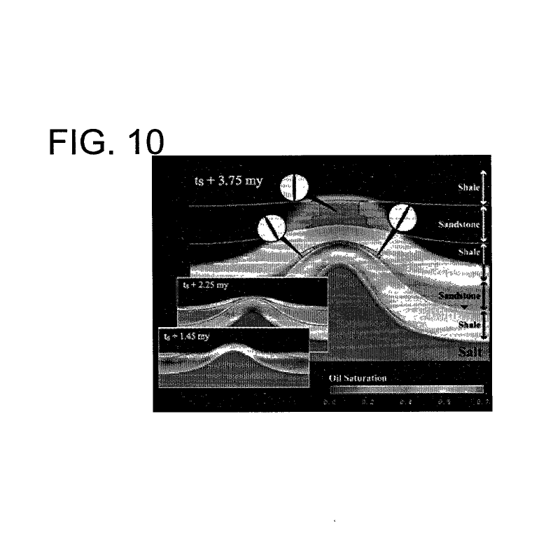

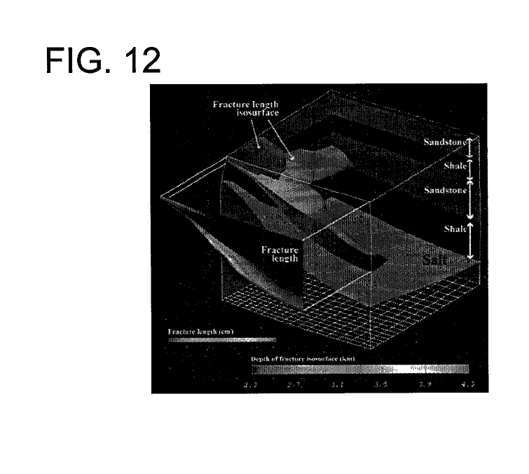

The interplay of salt deformation with the rheology of the surrounding strata is key to understanding the correlation between salt deformation and reservoir location. FIGS. 10 through 12 show simulation results produced by Basin RTM.

### Details of an Exemplary Embodiment

A complex network of geochemical reactions, fluid and energy transport, and rock mechanical processes underlies the genesis, dynamics, and characteristics of petroleum reservoirs in Basin RTM (FIG. 3). Because prediction of reservoir location and producibility lies beyond the capabilities of simple approaches as noted above, Basin RTM integrates relevant geological factors and RTM processes (FIG. 13) in order to predict fracture location and characteristics. As reservoirs are fundamentally 3-D in nature, Basin RTM is fully 3-D.

The RTM processes and geological factors used by Basin RTM are described in FIGS. 3 and 13. External influences such as sediment input, sea level, temperature, and tectonic effects influence the internal RTM processes. Within the basin, these processes modify the sediment chemically and mechanically to arrive at petroleum reserves, basin compartments, and other internal features.

Basin RTM predicts reservoir producibility by estimating fracture network characteristics and effects on permeability due to diagenetic reactions or gouge. These considerations are made in a self-consistent way through a set of multi-phase, organic and inorganic, reaction-transport and mechanics modules. Calculations of these effects preserve cross-couplings between processes (FIGS. 3 and 13). For example, temperature is affected by transport, which is affected by the changes of porosity that changes due to temperature-dependent reaction rates. Basin RTM accounts for the coupling relations among the full set of RTM processes shown in FIG. 3.

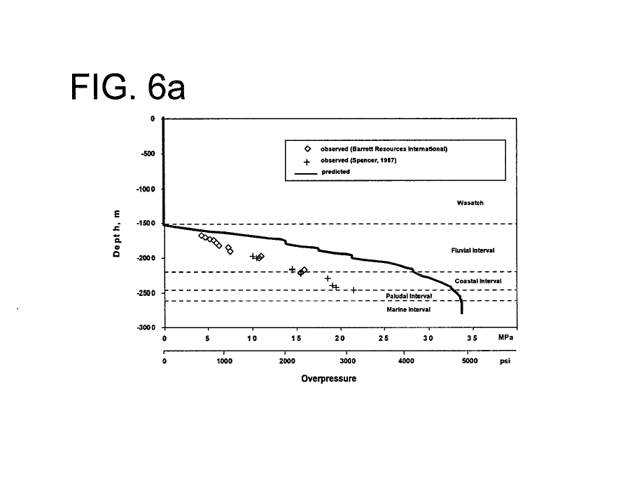

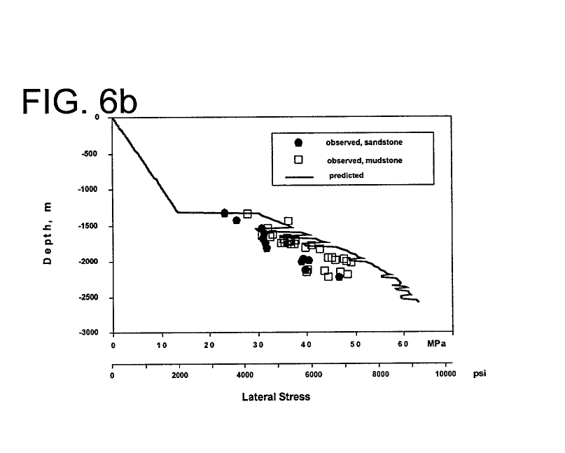

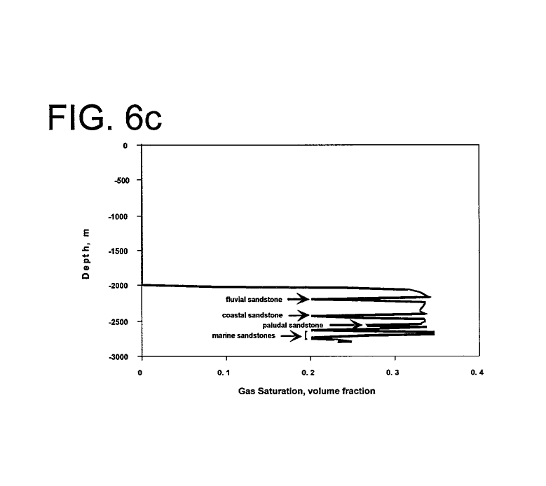

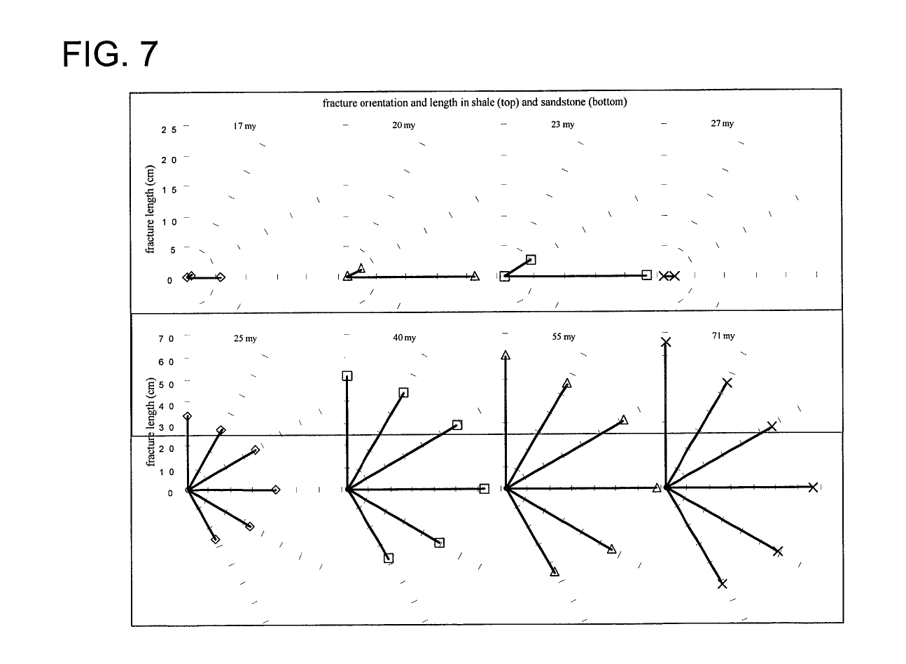

Key elements of the dynamic petroleum system include compaction, fracturing, and ductile deformation. These processes are strongly affected by basin stress history. Thus, good estimates of the evolution of stress distributions are useful in predicting these reservoir characteristics. As fracturing occurs when fluid pressure exceeds least compressive stress by rock strength, estimates of the time of fracture creation, growth, healing or closure, and orientation rely on estimates of the stress tensor distribution and its history. Simple estimates of least compressive stress are not sufficient for accurate predictions of fracturing and other properties. For example, least compressive stress can vary greatly between adjacent lithologies—a notable example being sandstones versus shale (see FIGS. 6 and 7). In Basin RTM, stress evolution is tightly coupled to other effects. Fracture permeability can affect fluid pressure through the escape of fluids from overpressured zones; in turn, fluid pressure strongly affects stress in porous media. For these reasons, the estimation of the distribution and history of stress must be carried out within a basin model that accounts for the coupling among deformation and other processes as in FIG. 3.

A rock rheological model based on incremental stress theory is incorporated into Basin RTM. This formalism has been extended to include fracture and pressure solution strain rates with elastic and nonlinear viscous/plastic mechanical rock response. This rheology, combined with force balance conditions, yields the evolution of basin deformation. The Basin RTM stress solver employs a moving, finite element discretization and efficient, parallelized solvers. The incremental stress rheology used is [symbol] . Here [symbol] is the net rate of strain while the terms on the right hand side give the specific dependence of the contributions from poroelasticity (el), continuous inelastic mechanical (in), pressure solution (ps), and fracturing (fr). The boundary conditions implemented in the Basin RTM stress module allow for a prescribed tectonic history at the bottom and sides of the basin.

The interplay of overpressuring, methanogenesis, mechanical compaction, and fracturing is illustrated in FIG. 4a. In this Piceance Basin simulation, fracturing creates producibility in the sandstones lying between the shales. In FIG. 4b, a similar source rock in the Ellenburger of the Permian Basin (West Texas) is seen to undergo cyclic oil expulsion associated with fracturing.

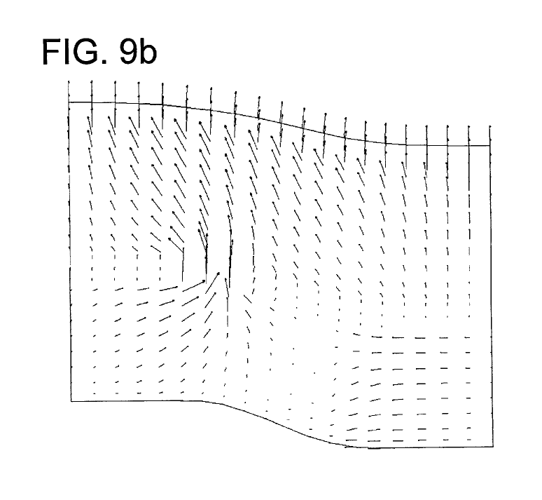

In FIGS. 9a and 9b, the results of Basin RTM show fault-generated fractures and their relation to the creation of fracture-mediated compartments and flow. This system shows the interplay of stress, fracturing, and hydrology with overall tectonism—features which give Basin RTM its unique power.

A key to reservoirs is the statistics of the fracture network. Basin RTM incorporates a unique model of the probability for fracture length, aperture, and orientation. The model predicts the evolution in time of this probability in response to the changing stress, fluid pressure, and rock properties as the basin changes. The fracture probability formulation then is used to compute the anisotropic permeability tensor. The latter affects the direction of petroleum migration, information key to finding new resources. It also is central to planning infill drilling spacing, likely directions for field extension, the design of horizontal wells, and the optimum rate of production.

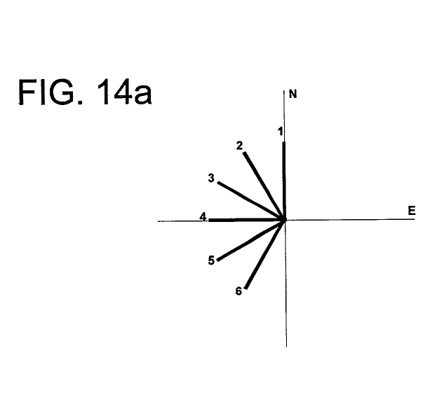

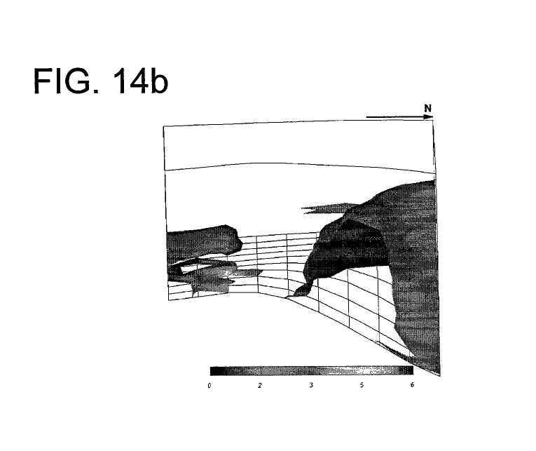

FIG. 14 shows a simulation using Basin RTM for Andector Field (Permian Basin, West Texas). Shown are the orientations of the predicted vertical fractures with their distribution across the basin.

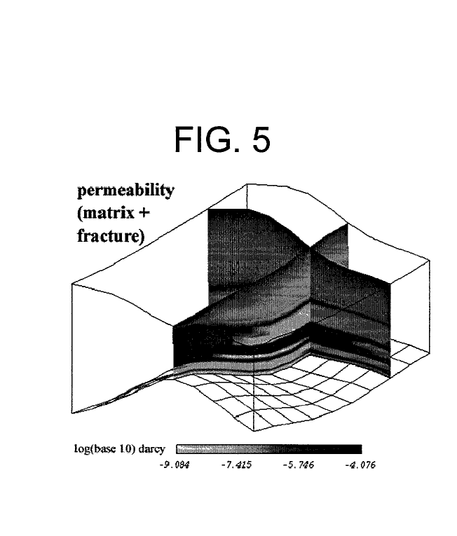

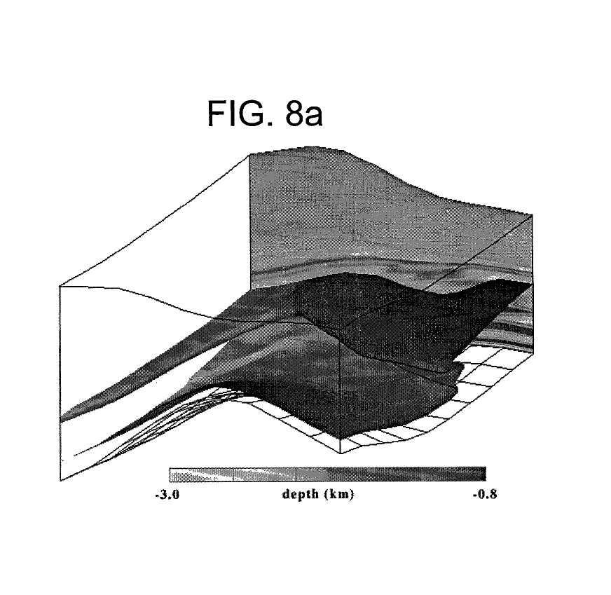

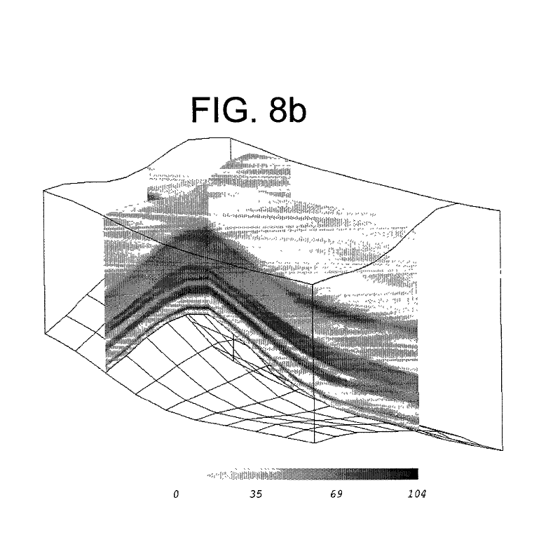

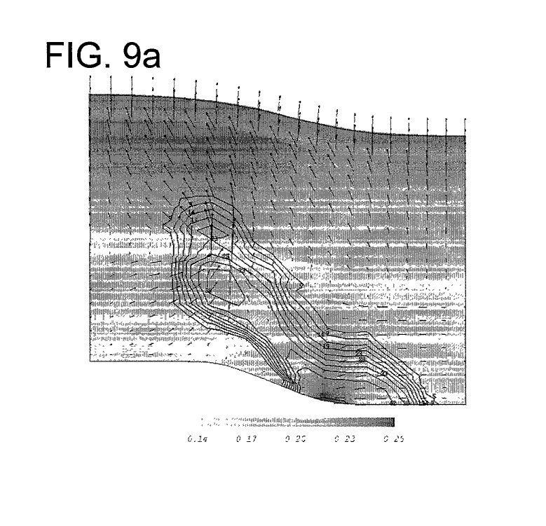

The fracture network is dynamic and strongly lithologically controlled. FIG. 7 shows fracture length-orientation diagrams for macrovolume elements in two lithologies at four times over the history of the Piceance Basin study area. The fractures in a shale are more directional and shorter-lived; those in the sandstone appear in all orientations with almost equal length and persist over longer periods of geological time. The 3-D character of the fractures in this system is illustrated in FIGS. 5 and 8.

Modules in Basin RTM compute the effects of a given class of processes (FIGS. 3 and 13). The sedimentation/erosion history recreation module takes data at user-selected well sites for the age and present-day depth, thickness, and lithology and creates the history of sedimentation or erosion rate and texture (grain size, shape, and mineralogy) over the basin history. The multi-phase and kerogen decomposition modules add the important component of petroleum generation, expulsion, and migration (FIGS. 6, 11, and 12). Other modules calculate grain growth/dissolution at free faces and grain-grain contacts (e.g., pressure solution). The evolution of temperature is determined from the energy balance. All physico-chemical modules are based on full 3-D, finite element implementation. As with the stress/deformation module, each Basin RTM process and geological data analysis module is fully coupled to the other modules (FIGS. 3 and 13).

Geological input data is divided into four categories (FIG. 13). The tectonic data gives the change in the lateral extent and the shape of the basement-sediment interface during a computational advancement time □t. Input includes the direction and magnitude of extension/compression and how these parameters change through time. These data provide the conditions at the basin boundaries needed to calculate the change in the spatial distribution of stress and rock deformation within the basin. This calculation is carried out in the stress module of Basin RTM.

The next category of geological input data directly affects fluid transport, pressure, and composition. This includes sea level, basin recharge conditions, and the composition of fluids injected from the ocean, meteoric, and basement sources. Input includes the chemical composition of depositional fluids (e.g., sea, river, and lake water). This history of boundary input data is used by the hydrologic and chemical modules to calculate the evolution of the spatial distribution of fluid pressure, composition, and phases within the basin. These calculations are based on single- or multi-phase flow in a porous medium and on fluid phase molecular species conservation of mass. The physico-chemical equations draw on internal data banks for permeability-rock texture relations, relative permeability formulae, chemical reaction rate laws, and reaction and phase equilibrium thermodynamics.

The spatial distribution of heat flux imposed at the bottom of the basin is another input to Basin RTM. This includes either basin heat flow data or thermal gradient data that specify the historical temperature at certain depths. This and climate/ocean bottom temperature data are used to evolve the spatial distribution of temperature within the basin using the equations of energy conservation and formulas and data on mineral thermal properties.

Lithologic input includes a list and the relative percentages of minerals, median grain size, and content of organic matter for each formation. Sedimentation rates are computed from the geologic ages of the formation tops and decomposition relations.

The above-described geological input data and physico-chemical calculations are integrated in Basin RTM over many time steps □t to arrive at a prediction of the history and present-day internal state of the basin or field. Basin RTM's output is rich in key parameters needed for choosing an E&P strategy: the statistics of fracture length, orientation, aperture, and connectivity, in situ stress, temperature, the pressure and composition of aqueous and petroleum phases, and the grain sizes, porosity, mineralogy, and other matrix textural variables.

The continuous aspects of the Basin RTM rheology for chalk and shale lithologies are calibrated using published rock mechanical data and well-studied cases wherein the rate of overall flexure or compression/extension have been documented along with rock texture and mineralogy. Basin RTM incorporates calibrated formulas for the irreversible, continuous and poroelastic strain rate parameters and failure criteria for chalk and shale needed for incremental stress rheology and the prediction of the stresses needed for fracture and fault prediction.

The texture model incorporates a relationship between rock competency and grain-grain contact area and integrates the rock competency model with the Markov gouge model and the fracture network statistics model to arrive at a complete predictive model of faulting.

Basin RTM's 3-D grid adaptation scheme (1) is adaptive so that contacts between lithologic units or zones of extreme textural change (i.e., narrow fault zones) are captured; and (2) preserves all lithologic contacts.

In the SEFD approach, Basin RTM is optimized whereby parameters that are key to the predictions, yet are less well-known, are computed by (1) generating a least-squares error (that represents the difference between the actual data and that predicted by Basin RTM and seismic recreation programs), and (2) minimizing the error using a conjugate gradient or other approach. Software implementing the SEFD techniques is optimized by:

parallelizing sparse matrix solvers;

multi-timing whereby variables that change more slowly “wait” several computational time-steps while faster ones are advanced; and

optimizing convergence criteria for various modules to obtain the best compromise for overall program speed and accuracy.

### Sample Cases: The New Albany Shale, Antrim Shales, the Austin Chalk, and Piceance and West Texas Basins

Basin RTM's ability to predict and characterize fractures may be shown by comparing observed fracture locations and characteristics with those predicted by the Basin RTM/SEFD approach. The sensitivity of the results to noise in the seismic data or other data uncertainties show the robustness of the approach. The effects of the uncertainties in the basin history parameters on the prediction of fracture characteristics, fluid pressure, porosity, and temperature are also examined. The overall (multi-process) dynamics of Basin RTM are compared with geological data on sample lithologies. Calibration is performed in an iterative fashion (simulate, recalibrate, repeat) for one or more fields such as those from the Austin Chalk, Piceance and West Texas Basins, and the Antrim Shale. Testing success is measured by assessing the percentage error between the SEFD-predicted and observed locations and properties of the reservoirs. These properties include fracture intensity, orientation and connectivity, reservoir permeability and other flow characteristics from production data, petroleum composition and reserve estimates, stresses and matrix properties (mineralogy, grain size, composition, grain breakage), and reservoir temperature.

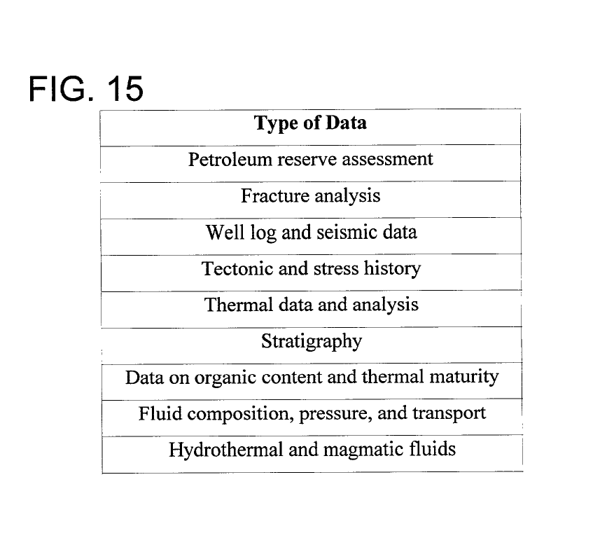

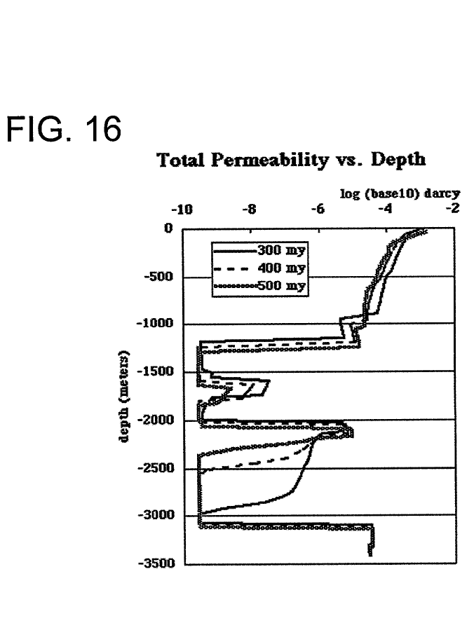

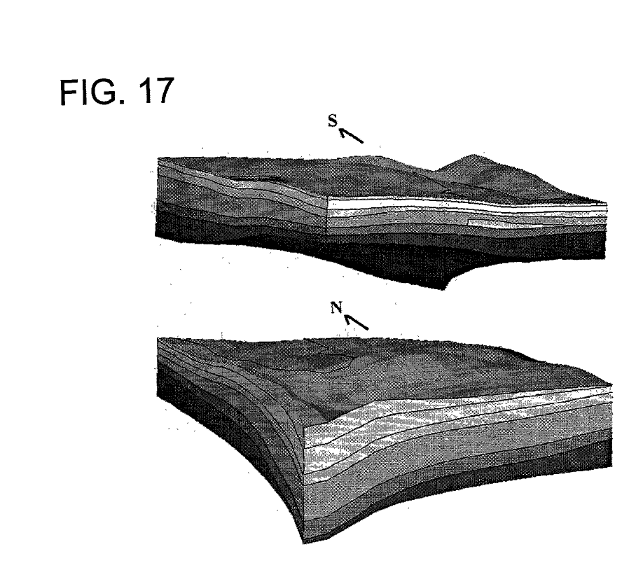

As a first example of the use of the SEFD technique, consider the Illinois and Michigan Basins, especially the New Albany and Antrim Shales. Abundant well control and other data are available for these basins. FIG. 15 summarizes the Illinois Basin data set available. A similar richness of data exists for the systems of FIG. 2. Input files for Basin RTM were compiled from these sources to determine the suitability of the available data (FIG. 16). Two wells are the focus of preliminary 1-D simulations, the Unocal No. 1 Cisne in Wayne County, Ill., and the Indiana Farm Bureau No. 1 Brown in Lawrence County, Ind. Simulations produced by Basin RTM revealed the evolution of porosity. The results show fracture enhancement of permeability during the last 200 million years of basin evolution (FIG. 16) and indicate that much new information can be learned about fracture location and characteristics through SEFD. FIG. 17 shows a Basin RTM-constructed 3-D section.

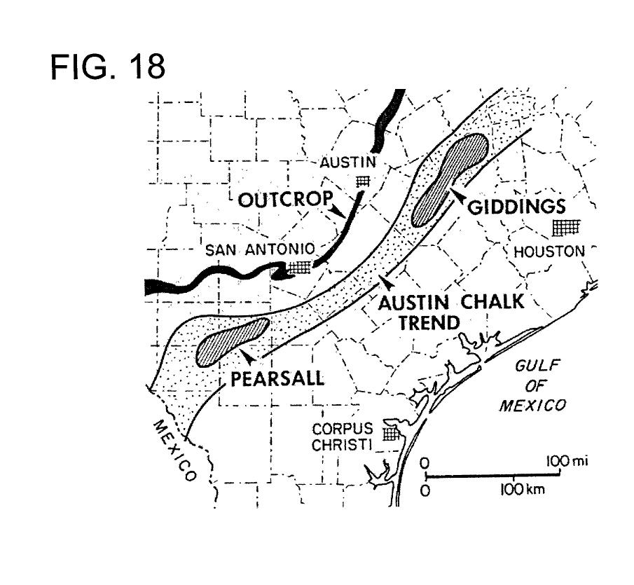

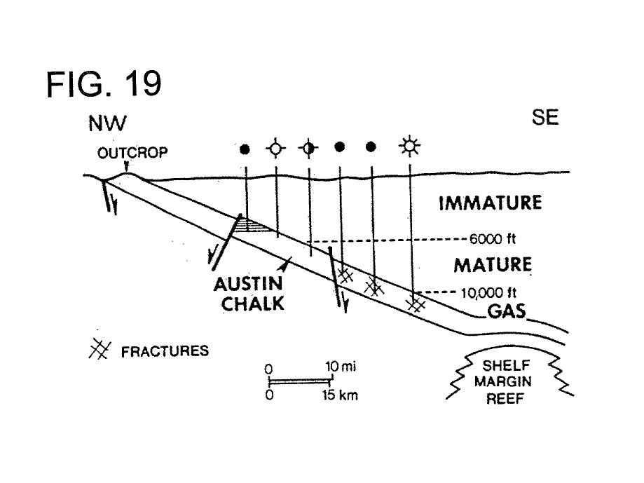

The second example, the Austin Chalk (AC), is a prolific, apparently self-sourced, formation in the onshore U.S. Gulf Coast (FIG. 18). As gas and oil producing zones (FIG. 19) are typically of low matrix permeability, fracture sweetspots are key to producibility. The difficulty in locating the latter is a serious limitation to the development of this resource.

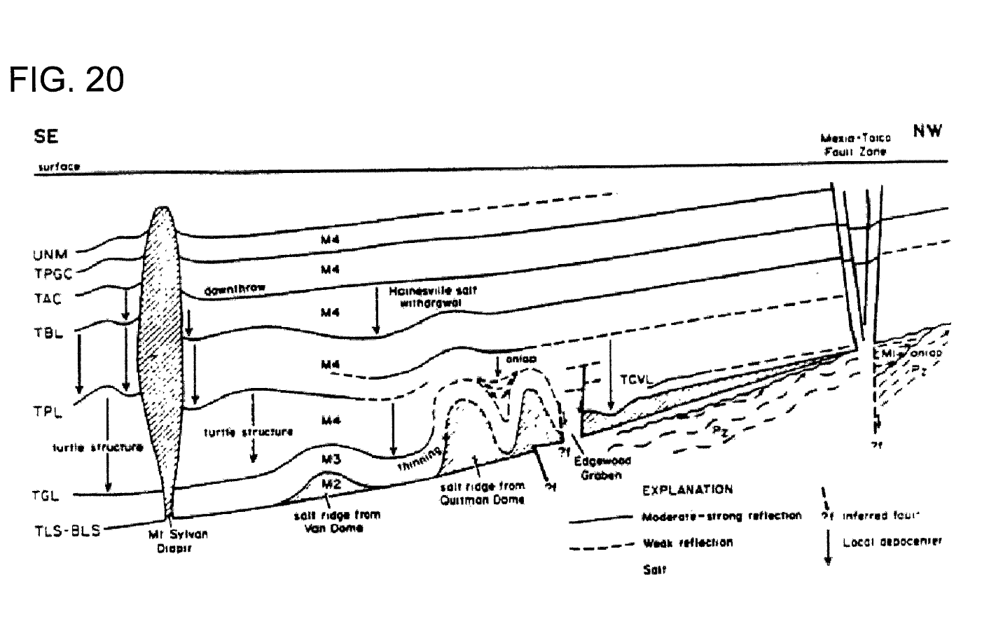

Large fractured reservoir systems are present in the Giddings and Pearsal Field areas and throughout the East Texas Basin (FIG. 20). The fractures have been attributed in part to petroleum generation. However, these fields are interspersed with and are surrounded by other fracture systems whose regularity is not always obvious. The possibilities of ancient controls related to salt motion should also be considered (FIG. 20) along with deeper-lying faults, thermal anomalies, and the overall extensional tectonics. Model-derived mapping of the aforementioned factors facilitates exploration and exploitation in this system.

The AC is one of the higher-lying formations in this play. The Jurassic Smackover limestone is very close to the salt. In fact, lower in the Texas Gulf Coast, salt diapirs directly affect the Smackover. Thus, it might be possible to locate other fracture plays that salt withdrawal may have created deep in the section. The SEFD mapping are useful in lease acquisition and planning. Mapping of these fracture zones and fixing their time of formation is an important part of the SEFD prospectivity analysis. These likely subtle fracture systems are discernible remotely with the insight of the forward, dynamic fracture modeling and SEFD approach.

### Automated Well Log and Geochemical Data/Basin Modeling E&P Approach for Deep Natural Gas and Compartmented Regimes

Predicting reservoir location and characteristics is key to the cost-effective exploration and production of deep natural gas and compartmented systems. The method according to the invention integrates and automates the use of well log, geochemical, and seismic data with quantitative basin modeling to achieve this predictability. This method uses the laws of physics and chemistry to predict reservoir porosity, permeability, fracture network characteristics, gas composition and saturation, state of stress, and rock strength as well as overall reservoir extent and geometry.

Conventional well log analysis often yields unreliable information due to the invertibility problem. A variety of fluid/rock states (grain size, shape, and packing for all minerals; fracture network statistics; and porosity, wetting, saturation, and composition of each fluid phase) yields the same logging response. Geochemical data (pore fluid composition, fluid inclusion analyses, and vitrinite reflectance) are often ambiguous indicators of geological history due to variations in pore-fluid composition and temperature during basin evolution. Furthermore, the interpretation of well log and geochemical data is labor-intensive. Therefore, the maximum benefits of this data are often not realized. The technique according to the invention greatly reduces the ambiguities and automates the use of this data to predict reservoir location and characteristics, focusing on the special challenges of deep gas, compartmented reservoirs, and associated by-passed reserves.

The approach is based on the facts that fluid/rock state implies a unique well logging tool response and detailed basin history implies unique geochemical data. The 3-D basin reaction, transport, mechanical model is used to compute fluid/rock state across a study area and uses this information to construct synthetic well logs and geochemical data. Errors in the predicted logs and geochemical data (compared to observed data) are minimized by varying least-well-known basin history parameters (specifying basement heat flux and overall tectonic and other geological history information) or additional quantities. The result is an automated procedure for optimizing the basin model's prediction of the location, extent, and internal characteristics (hydrologic and mechanical) of reservoirs as well as the prediction of detailed information about seals and estimated reserves.

Using 3-D finite-element methods, Basin RTM solves equations for rock deformation, fracturing, multi-phase flow, mineral and organic reactions, and heat transfer. The organic kinetics of the basin model are augmented, and the model uses available formulas to compute synthetic well logs from the Basin RTM-predicted spatial distribution of fluid/rock state. The model is extended to compute vitrinite reflectance and fluid inclusion data. These upgrades improve the ability of the model to identify compartment-defining seals and deep reservoir characteristics and to simulate organic kinetics of deep-gas-generation processes. The technology is tested on a well-studied, promising U.S. petroleum regime, the Anadarko Basin, wherein both compartmentation and deep reserves are abundant. The technology maximizes the use of existing well log, seismic, and geochemical data and guides the acquisition of new data. The technology provides specific guidance for gas resource development in the Anadarko Basin. The findings are extrapolated to other basins.

The potential for discovering new fields and for identifying by-passed petroleum in U.S. basins is tremendous via the fully automated log/geochemical data-basin RTM modeling technology. The basin model is implemented in three dimensions and has a complete set of fluid and mineral state variables needed to make this approach feasible.

For many basins worldwide, the petroleum industry has large stores of data. Much of this data, often acquired at great expense, have not been adequately used. The basin model provides a revolutionary approach that automatically synthesizes this data for E&P analysis, focusing on the special challenges of deep gas and compartmented regimes. The typical information available includes seismic, well log, fluid inclusion, pore fluid composition and pressure, temperature, vitrinite reflectance, and core characterizations.

The use of this data presents several challenges:

the need to extrapolate away from the well or down from the surface;

the presence of omnipresent noise or other measurement error;

the time-consuming nature of the manual interpretation of this data; and

the lack of an unambiguous prediction of reservoir location and characteristics from this data.

In the latter context, well logs or seismic data, for example, cannot be used to unambiguously specify the local fluid/rock state (shape, packing and mineralogy, grain size, porosity, pore fluid composition, and fracture network statistics). In the present approach, the uniqueness of the fluid/rock state to seismic/well log response relationship is exploited (similarly for the geochemical data). This avoids the ambiguity in the inverse relationship, seismic/well log data to fluid/rock state, on which log or seismic interpretation is based at present.

The pathway to achieving this goal is via comprehensive basin modeling. The basin model is a three-dimensional model that uses finite element computer simulations to solve equations of fluid and mineral reactions (R), mass and energy transport (T), and rock mechanics (M) to predict all fluid/rock state variables needed to compute seismic, well log, and other data. The difference between the basin model-predicted well log and geochemical data and the actual observed data provides a method for optimizing both the interpretation of the data and the richness of the reservoir location and characteristics predicted by the 3-D model, Basin RTM.

The variables predicted by the n RTM simulator at all points and all times in the basin include:

pressure, composition, and saturation of each pore fluid phase;

temperature and stress;

size, shape, and packing of the grains of all minerals;

fracture network (orientation, aperture, length, and connectivity) statistics; and

porosity, permeability, relative permeabilities, and capillary pressures.

To make these predictions, however, the Basin RTM simulator needs information on basin history parameters (sedimentary, basement heat flux, overall tectonic, and other histories) which themselves are often poorly constrained.

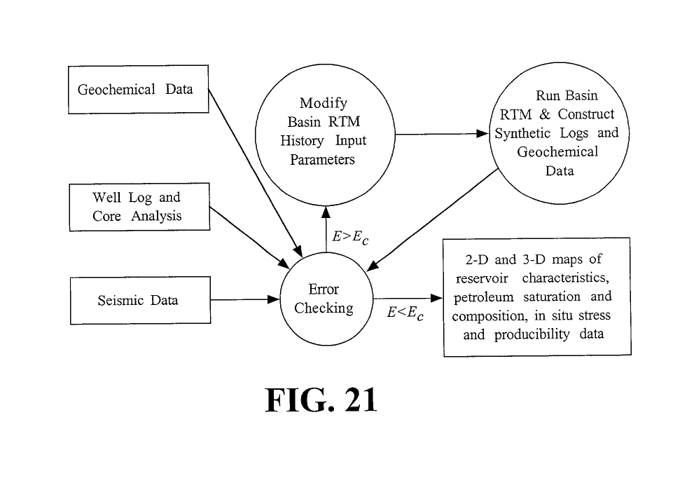

FIG. 21 presents a new method for resolving this dilemma. The Figure shows the automated procedure for using all the measured data to fix the overall basin history parameters and, thereby, gain the level of detailed predictions needed to locate reservoirs and assess their characteristics in advance of drilling. More specifically, the model works as follows. Digitized data (seismic, well log and geochemical information, fluid phase saturations, core analysis, etc.) are the input to a computer program. Estimates of geological history parameters are used by the program to run the Basin RTM simulator. The output of Basin RTM is used to compute synthetic seismic, well log, geochemical, and other data. The error (difference between the observed and synthetic data) is then checked. An iteration scheme is used wherein this cycle is repeated, modifying the geological history data until the error is minimized. This yields the best values of the geological history parameters. Basin RTM, run with these optimized parameter values, yields the predicted location and characteristics of petroleum reservoirs. In the present context, the focus is to meet the special challenges of deep gas and compartmented reservoirs.

The model focuses on well logs, fluid pressure, vitrinite reflectance, and fluid inclusions. It includes formulas that yield the synthetic data from the rock/fluid state as predicted by the Basin RTM output variables. The organic kinetics model is improved to predict the many chemical species quantified in the pore fluid composition, fluid inclusion, and vitrinite reflectance data.

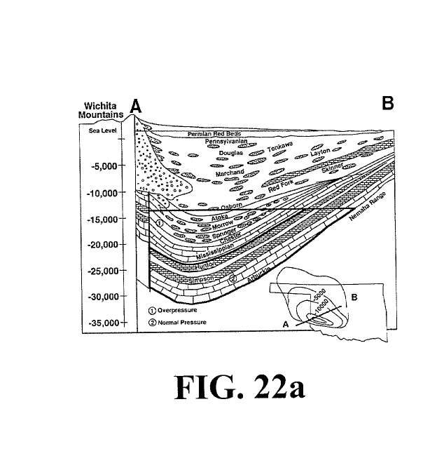

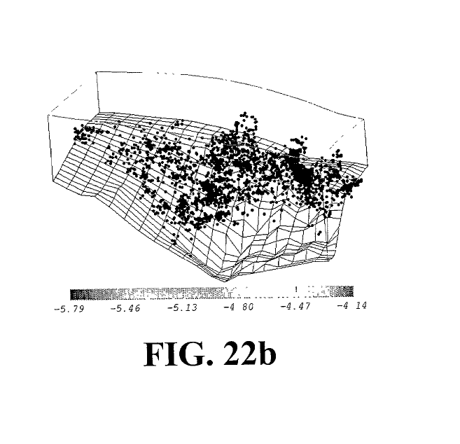

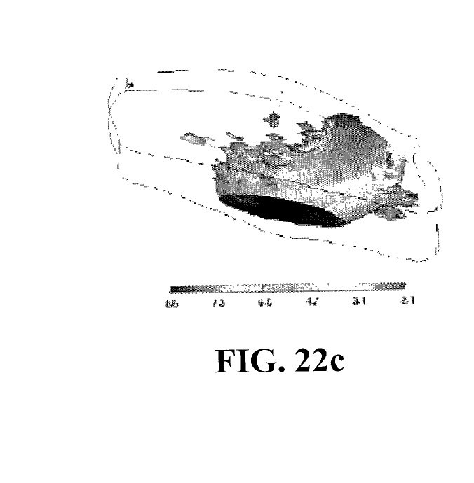

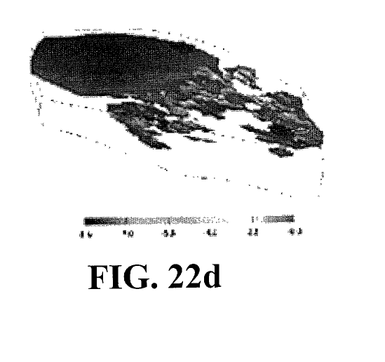

The Anadarko Basin (FIG. 22) is chosen as a test site because of:

the deep petroleum reservoirs and compartments already identified;

its acknowledged potential for remaining reserves;

the completeness of the available data set; and

familiarity with the Anadarko Basin and the extensive database on it.

The present basin model:

includes formulas relating fluid/rock state to well logging tool response;

includes a chemical kinetic model for type-II kerogen and oil cracking that simulates deep gas generation, models the relation between vitrinite reflectance and the kerogen composition, and integrates the above with the 3-D multi-phase, miscible fluid flow model;

implements the measured data/Basin RTM integration technology as in FIG. 21; and

expands and formats the Anadarko Basin database for use as in FIG. 21 and uses graphics modules to probe the data;

Through its automated use of measured data (as in FIG. 21), this technology greatly increases the identified U.S. reserves. As the technology predicts both reservoir quality and location, it greatly improves the economics of production and limits loss from by-passed oil and gas.

A complex network of geochemical reactions, fluid and energy transport, and rock mechanical processes underlies the genesis, dynamics, and characteristics of a sedimentary basin and the petroleum reservoirs within it (see FIG. 3). Therefore, prediction of reservoir location and characteristics lies outside the realm of simple approaches. The Basin RTM simulator accounts for all the geological factors and RTM processes presently believed to be important for understanding the dynamic petroleum system. As reservoirs are fundamentally 3-D in nature, the simulator is fully 3-D.

The RTM processes and geological factors accounted for in Basin RTM are outlined in FIGS. 3 and 13. External influences such as sedimentation/erosion, sea level, basement heat flux, and overall tectonic histories are allowed to influence the internal RTM processes through their effects at a basin's boundaries. The RTM processes modify the sediment chemically and mechanically within a basin to produce faults, petroleum reservoirs, and other features.

Basin RTM provides a platform for integrating all available geological data as suggested in FIG. 13 using the framework provided by the laws of physics and chemistry. RTM processes accounted for are rock deformation, diagenesis, heat transfer, multi-phase flow, kerogen reactions, and fracture statistics. These physical and chemical processes are used to evolve the internal state of the basin from its inception to the present.

Key to predicting reservoir location and characteristics in deep gas and compartmented regimes are compaction, fracturing, and ductile deformation. These processes are strongly affected by basin stress history. Thus, reliable estimates of the evolution of stress distribution within the basin are useful in predicting these reservoir characteristics. As fracturing occurs when effective least compressional stress exceeds rock strength, estimates of the time of fracture creation, growth, healing or closure, and orientation rely on estimates of the stress tensor distribution and its history. In Basin RTM, stress evolution is tightly coupled to other effects. For example, fracture permeability can affect fluid pressure through the escape of fluids from overpressured zones; in turn, fluid pressure strongly affects stress in porous media. For these reasons, the estimation of the history of the distribution of stress and deformation is carried out within a basin model that accounts for the coupling among all RTM processes as in FIG. 3.

The following features show the comprehensiveness of the rock/fluid state description and the completeness of the set of chemical and physical processes evolving them. This richness makes it possible to integrate well logging, geochemical, and other data with basin modeling.

Incremental stress rheology is used to integrate poroelasticity, viscous flow with yield behavior, fracturing, and pressure solution. In most studies sediments are considered as either nonlinear Newtonian fluids or as elastic media, thereby ignoring the effects of faulting and fracturing (see FIGS. 7, 8, and 23).

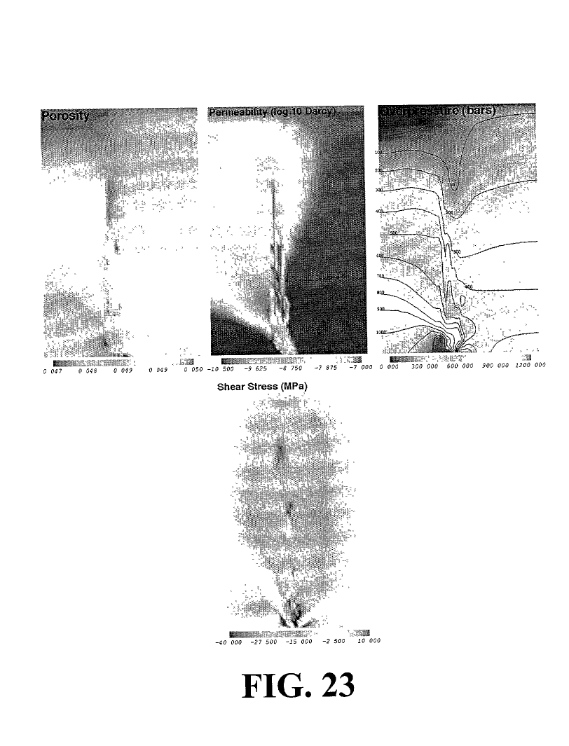

Faulting occurs via a Drüker-Prager criterion to signal failure, and a texture dynamics model is used to compute the evolving, associated rheologic properties (FIG. 23).

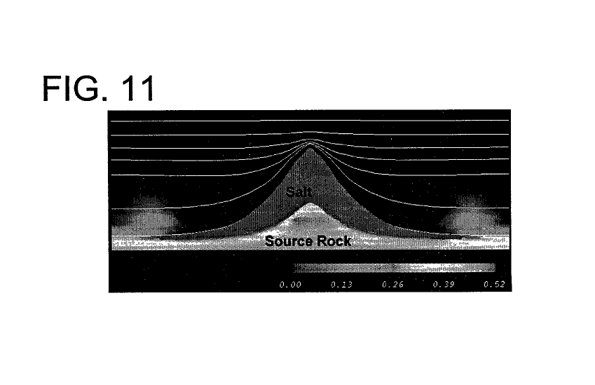

Petroleum generation/rock deformation and multi-phase flow are solved simultaneously to capture seals, abnormally pressured compartments, and petroleum expulsion (FIGS. 4 and 11).

Inorganic and organic solid state and fluid reactions and their temperature and ionic state dependencies are accounted for.

Grain growth/dissolution, breaking of grain-grain contacts, pressure solution, and gouge evolve rock texture.

A 3-D computational platform is used. Other basin simulators are limited to 2-D or a few processes. Nonlinear dynamical systems have a strong dependence on spatial dimensionality. Therefore, a 3-D computational platform is useful for gaining a better understanding of fracture networks and reservoirs and the dynamical petroleum system (FIGS. 7 and 8).

A 3-D fracture network dynamics accounts for the stress tensor, fluid pressure, and rock texture variables. Since previous models are limited to simulating the behavior of bulk materials, they are not used to predict or understand tensile fractures which contribute to the tensorial rock permeability (see FIGS. 7 and 8). An example of episodic fluid release through fracturing is shown in FIG. 4b. FIG. 7 shows fracture length orientation diagrams for macrovolume elements in two lithologies at four times over the history of the Piceance Basin study area. Note that the fractures in a shale are more directional and are shorter-lived. In contrast, those in the sandstone appear in all orientations with almost equal length and persist over longer periods of geological time. The 3-D character of the fractures in this system is illustrated in FIG. 8b.

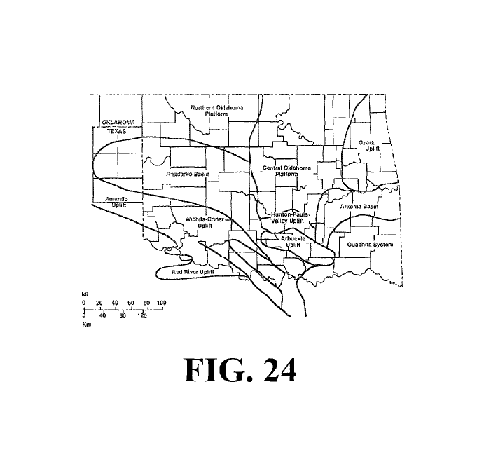

A sedimentary basin is typically divided into a mosaic of compartments whose internal fluid pressures can be over (OP) or under (UP) hydrostatic pressure. An example is the Anadarko Basin as seen in FIGS. 22 and 24. Compartments are common features worldwide. Compartments are defined as crustal zones isolated in three dimensions by a surrounding seal (rock of extremely low permeability). Identifying them in the subsurface is key to locating by-passed petroleum in mature fields. Extensive interest in these phenomena has been generated because of their role as petroleum reservoirs.

Compartmentation can occur below a certain depth due to the interplay of a number of geological processes (subsidence, sedimentation, and basement heat flux) and physico-chemical processes (diagenesis, compaction, fracturing, petroleum generation, and multi-phase flow). These compartments exist as abnormally pressured rock volumes that exhibit distinctly different pressure regimes in comparison with their immediate surroundings; thus they are most easily recognized on pressure-depth profiles by their departure from the normal hydrostatic gradient.

Integrated pore-pressure and subsurface geological data indicate the presence of a basinwide overpressured compartment in the Anadarko Basin. This megacompartment complex (MCC) is hierarchical, i.e., compartments on one spatial scale can be enclosed by compartments on large spatial scales (see FIG. 22). The Anadarko MCC encompasses the Mississippian and Pennsylvanian systems and it remained isolated through a considerably long period of geological time (early Missourian to present). Compartments within the MCC are isolated from each other by a complex array of seals. Seal rocks display unique diagenetic banding structures that formed as a result of the mechano-chemical processes of compaction, dissolution, and precipitation.

The Anadarko Basin is considered the deepest foreland Paleozoic basin on the North American craton. Located in western Oklahoma and the northern Texas Panhandle, this basin covers an area of approximately 90,639 km² (35,000 mi²) (FIG. 24). It is bounded to the east by the Nemaha Ridge and by the ancient eroded Amarillo-Wichita Mountain Front to the south. To the west and north, the Anadarko Basin is flanked by a shallow platform area (see FIG. 9).

The deep part of the Anadarko Basin (>16,000 ft) consists of two major types of reservoirs with distinct pressure regimes:

(1) Pennsylvanian (Morrow and Red Fork) siliciclastic rocks: these reservoirs are overpressured and they are part of the MCC. They exhibit a variety of lithologies ranging from quartz arenite and lithic arenite to chert conglomerate and granite washes. Integrated pore-pressure and subsurface data indicate that the Red Fork and Morrow reservoirs form a myriad of completely isolated smaller compartments within the MCC. A compartment hierarchy was established based on compartment size and distribution. A complex network of seals separates these compartments. The size and geometry of compartments are strongly linked to their depositional setting and facies. The southern lateral boundary of the MCC is formed by a highly cemented section of conglomeratic rocks. These conglomerates are adjacent to the bounding faults of the Wichita-Amarillo uplift, but contain significant reserves distal to the fault zone. Preliminary estimates of the natural gas reserves of the MCC are approximately 20 trillion cubic feet (FIG. 22a).

(2) Ordovician, Silurian, Devonian (Hunton, Simpson, and Arbuckle Groups): these reservoirs which are normally-pressured are composed mainly of carbonates and occur in the deepest part of the basin. Gas trapped in these rocks is the result of a complex interaction of facies, diagenesis, and structure. This portion of the rock column is least explored and contains a high potential for new discoveries. The reserves estimate of this interval is not documented due to inadequate available data. Modeling the Anadarko Basin could provide a significant tool for understanding this part of basin and therefore give a more accurate picture of the natural gas reserves (FIG. 22a).

Compartments have a reciprocal relation with faults. Besides apparently being key intra-fault features, compartments are often bounded on their sides by faults that serve as vertical seals (FIG. 22). However, compartments can exist in unfaulted regions and therefore are also addressed independently of faults.

A chemical kinetic model of natural gas generation from coal is used to model the deep gas generation problem. The new kinetic model for gas generation is based on the structure of lignin, the predominant precursor molecule of coal. Structural transformations of lignin observed in naturally matured samples are used to create a network of eleven reactions involving twenty-six species. The kinetic model representing this reaction network uses multi-phase reaction-transport equations with n^{th} order processes and rate laws. For the immobile species, i.e., those bound with the kerogen, the rate equations take the form

$$\frac{ⅅ {C}_{i}}{ⅅ t} = {\sum }_{a} {v}_{ia} {k}_{a}^{eff} {\prod }_{{i}^{′} , {v}_{{i}^{′} a} \geq 0} {C}_{{i}^{′}}^{{v}_{{i}^{′} a}} \qquad ( 1 )$$

where Cᵢ is moles of immobile kerogen species i per kerogen volume, and k_{α}^{eff} is an effective rate coefficient for reaction α that consumes one or more reactant molecules (v_{αi}>0) and generates product molecules (v_{iα}>0). We assume that the kerogen reactions are irreversible.

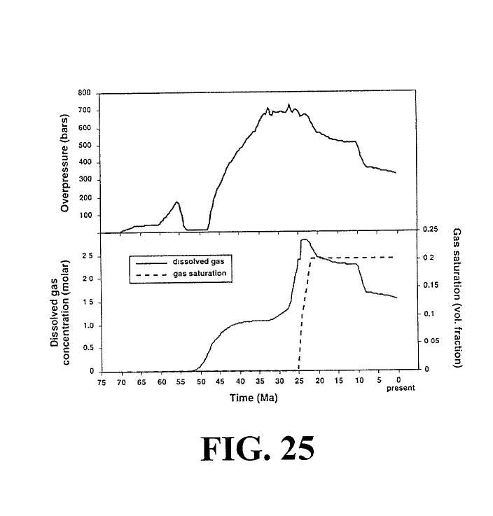

D/Dt in Equation (1) represents a time derivative in the reference frame moving with the deforming rock. This formulation yields the composition of the residual solids either in the kerogen or as deposited subsequently during migration. For species which can exchange between the organic solids and the single or multiple pore fluid phases, the model uses miscible, multi-Darcy reaction-transport laws (see FIGS. 6c and 25). However, the model may use advanced multi-phase flow law to account for the dynamic wetting and other pore-scale geometric features of the oil/gas/water miscible flow system.

The model uses a simplified guaiacy/polymer as the assumed starting lignin structure. The structural transformations are captured in fifteen processes which are represented by four classes of reactions: isomerization, modification of the propyl structure, defunctionalization, and cross- linking. These processes lead to the evolution of mobile phases, such as H₂O, CO₂, CH₄, and an increasingly aromatized immobile residue.

FIG. 25 compares the fluid pressure history of the coastal interval sandstone (Upper Cretaceous Mesaverde Group in the Piceance Basin, northwest Colorado) with gas saturation (pore volume occupied by gas phase generated from underlying source rocks). Starting at about 52 Ma, after incipient maturation of the underlying source Crock (the paludal interval coal), gas is initially transported into the sandstone dissolved in pore fluids. Aqueous methane concentration increases as more gas is generated from maturing source rocks and as pore fluid migrates upward into the sandstone from compacting and overpressuring source rocks below. Aqueous methane concentration continues to increase until its peak at about 25 Ma. At this time, aqueous methane concentration begins to decrease and the free gas phase forms. The gas phase is exsolving from the aqueous phase because uplift and erosion are decreasing the confining stresses and decreasing the solubility of the gas in the aqueous phase. Aqueous methane continues to decline for the remainder of the simulation, and gas saturation is maintained at about 20%.

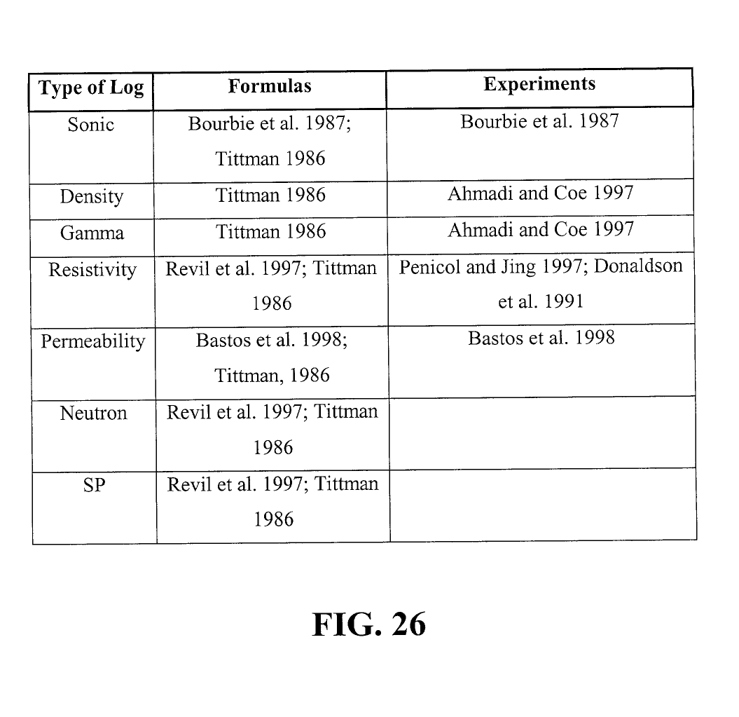

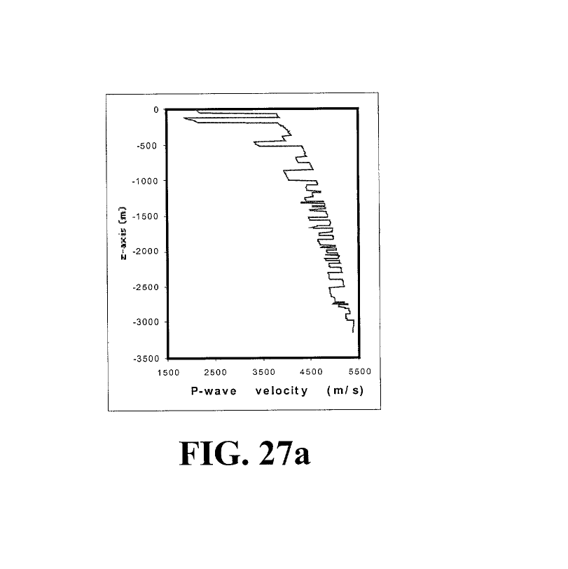

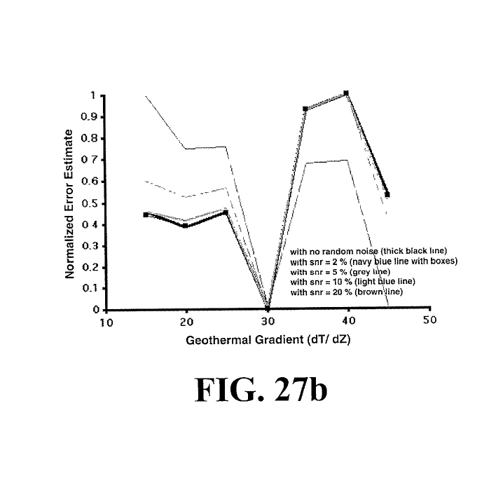

To use well logs in the data/modeling scheme of FIG. 21, the model generalizes formulas from the literature (see FIG. 26) relating log tool response to fluid/rock state. A preliminary synthetic sonic log for the Piceance Basin (Colorado) is shown in FIG. 27. These logs were computed using Basin RTM-predictions of the size, shape, and packing of the grains of all minerals, porosity, pore fluid composition, and phase (state of wetting), and fracture network statistics.

Relations between well log response and fluid/rock state have been set forth for a number of logging tools. A brief summary of theoretical formulas or experimental correlations and references is given in FIG. 26. The published and new fluid/rock state to log tool response relations are recast in terms of the specific fluid/rock variables predicted by Basin RTM.

The new formulas are based on volume averaging for sonic, resistivity, and other logs and homogenization and multiple time scale methods. The model accounts for the effects of chemical reactions and phase transitions on the propagation of sound, electrical conduction in reacting porous media, electromagnetic waves in chemically complex media, the effects of surface charge and self-potentials, and the fundamentals of neutron scattering.

The logging tool response is a unique function of fluid/rock state. Its use avoids the nonuniqueness of the inverse relation that is the basis of all log interpretation methods presently available. The model uses the new fluid/rock state log response formulas to compute the synthetic well logs in the algorithm of FIG. 21.

A chemical kinetic model generalizing the lignin model accounts for the chemical speciation of the precursor organic molecules expected for the Anadarko Basin. The major petroleum source rock in the Anadarko Basin is the Upper Devonian and Lower Mississippian Woodford Shale. The Woodford Shale, which is more than 600 feet thick along the basin axis, is a marine deposit that contains as much as 26% organic carbon by weight, comprising predominantly oil-prone type-II kerogen. Other petroleum source rocks include marine shales of Ordovician, Late Mississippian, and Early Pennsylvanian age. The pre-Mississippian rocks contain mostly type-II kerogen and the Mississippian and younger rocks contain mostly type-IIl (coaly) kerogen. The model uses a new kinetic approach to modeling the thermal generation of petroleum from type-II kerogen and the cracking of crude oil to natural gas in its efforts at assessing deep gas reserves and the location and characteristics of the associated reservoirs.

This approach to modeling the thermal generation of oil and gas from type-II kerogen is similar to that adopted for gas generation from coal. A result of an earlier method is seen in FIG. 25. Differences between this approach and that of other organic kinetic models arise from attention to the actual (vs. overall) kinetic network. The model uses this unique approach to create a new kinetic model for oil and gas generation from type-II kerogen. For type-II kerogen the dominant biological precursor molecules are lipids. The model focuses on those few lipid molecules that are predominant in the marine organisms comprising the algae and plankton that constitute type-II kerogen. From these basic lipid structures, a network of nth order reactions is developed that yields the various immobile kerogen entities as well as those mobile species that constitute crude oil and associated natural gas. In addition, the reactions that crack crude oil hydrocarbons to produce the C1 to C5 species that characterize thermogenic natural gas are also included in the overall reaction network. Including the hydrocarbon cracking reactions in the new chemical kinetic model captures the processes whereby huge amounts of natural gas are generated from oil-prone type-II kerogen at very high temperatures such as those encountered in the deep parts of sedimentary basins. The model uses molecular dynamics and the new atomic force field to predict the many rate coefficients that enter the detailed kinetic model, checking the results with published experimental data and type-II kerogen.

The model predicts thermal maturity based on the chemical kinetic model discussed above and on the predicted chemical composition of the residual organic fraction. Vitrinite reflectance is a relatively quick, inexpensive, and reliable measurement, and it is widely used, extensively tested and calibrated to both oil and gas generation and to many other thermal maturity indices such as coal rank, thermal alteration index, kerogen elemental composition (%C and H/C ratio), and biomarker ratios. Vitrinite consists of the remains of woody plant tissue, the predominant resistant molecule of which is lignin. To simulate vitrinite reflectance, the model uses a working model for natural gas generation from lignin, tracking the changes in composition of the residual organic phase that results from the network of lignin structural transformations. By assuming that the reflectance of vitrinite (%Ro) changes smoothly as its chemical composition changes, then

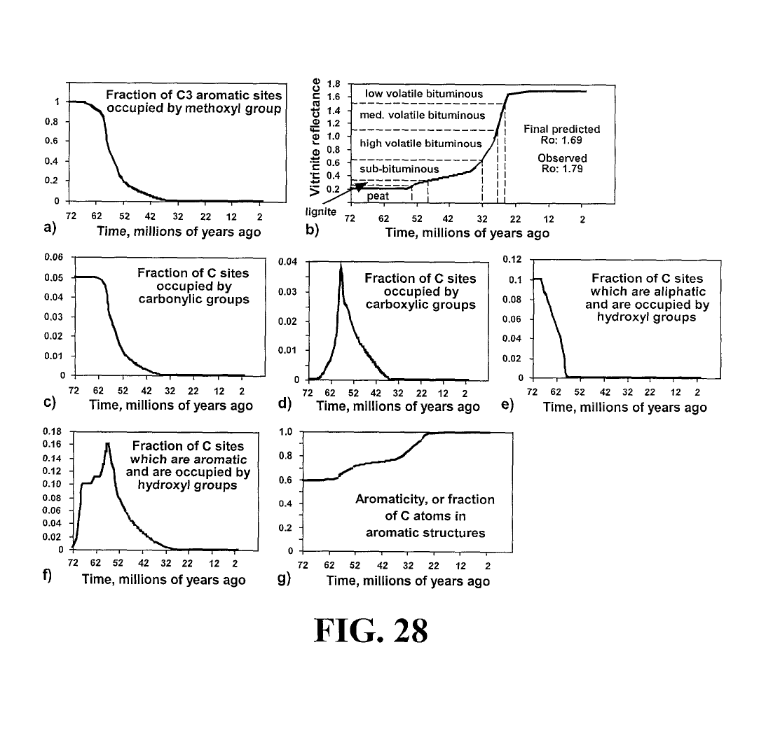

%Ro=12 exp [−3.3(H/C)]−(O/C)] (2)

where H, C, and O refer to the atomic proportions of these elements in vitrinite. The model uses this relationship to simulate the evolution of vitrinite reflectance using the model for gas generation from lignin (FIG. 28).

The model captures those thermal maturation indices that are derived from the elemental composition of the total kerogen, such as the percent elemental carbon and the atomic H/C and O/C ratios, by capturing the elemental chemistry of the residual phases resulting from lignin maturation, the new advanced chemical kinetic model for oil generation from lipids, and the cracking of crude oil to natural gas. By simulating these thermal maturity indices, the model becomes an automated method for comparing basin modeling results with observed values.

To account for the many species described by the organic kinetics model, the model uses a new multi-phase flow model and solver. This model describes multi-phase flow and the changing intra-pore geometry of the phases (wetting/nonwetting, continuous phase/droplet, or surface-attached patch). The model includes Nₛ, components in each of the three possible fluid phases (oil, aqueous, gas) and the organic solid phase. It is preferable to have Nₛ≈20 to fully use the extensive fluid inclusion data available. All Nₛ species are allowed to exchange between all three possible phases; the exchange process is assumed to be at equilibrium. To make the computation feasible in 3-D, the model uses parallel algorithms.

Consider the use of a sonic log to determine the geothermal gradient that operated during basin evolution. To demonstrate the model's approach, use a Basin RTM simulation run at 30° C./km as the observed data, shown in FIG. 27a. FIG. 27b is a plot of the quadratic error E (the sum of the squares of the difference in observed log values and their Basin RTM synthetic log values at a given geothermal gradient). Note the well pronounced minimum at the correct geothermal gradient. What is most encouraging is that the existence of a minimum in E vs. geothermal gradient remains even when the observed data contains random noise. As seen in FIG. 27b, the error has a perceivable minimum at about 30° C./km, proving the practicality of our approach in realistic environments.

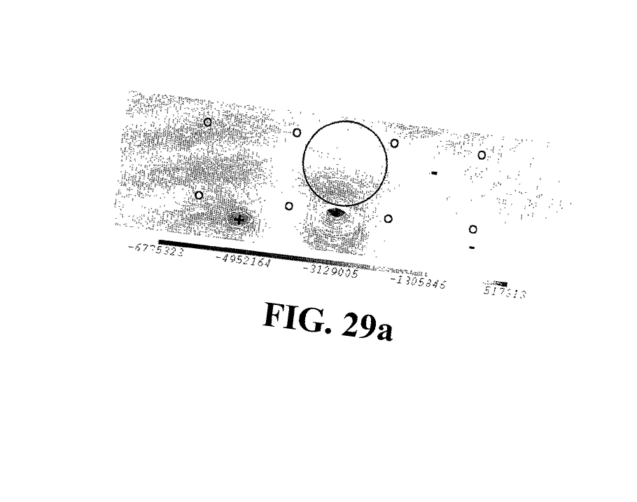

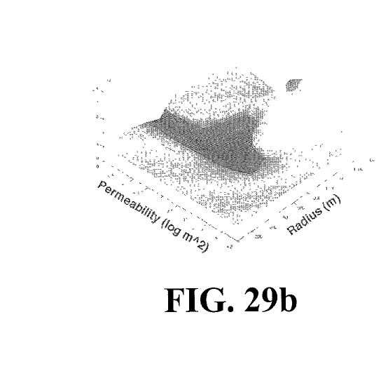

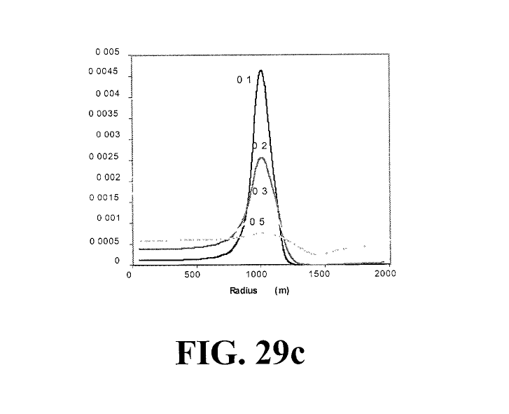

The method similarly shows promise when used to determine multiple basin history or other variables. To illustrate this point, consider a production problem wherein the objective is to find the spatial extent of and permeability in a zone of enhanced permeability within a reservoir (the circular zone in FIG. 29a). FIG. 29a shows a vertical cross-section and indicates the location of production and injection wells represented by (−) and (+), respectively. FIG. 29b shows a 3-D depiction of the dependence of the quadratic error on the radius of and permeability in the circular zone of enhanced permeability. The dark blue and red zones of FIG. 29b indicate the minimum and maximum error, respectively. The model uses efficient ways of finding the global minimum of the error in the space of the basin history parameters.

The model also incorporates a risk assessment approach based on information theory. The method differs from others in geostatistics in that it integrates with basin simulation as follows. Information theory provides a method to objectively estimate the probability ρ of a given set A (=A₁, A₂,Λ A_{N}) of N parameters which are the most uncertain in the analysis. For the present problem, these include basement heat flux, overall tectonics, sedimentation/erosion history, etc. The entropy S is then introduced via S=−∫d^{N}Aρλnρ which is found to be an objective measure of uncertainty. The information theory approach is then to maximize S constrained by the information known, the result being an expression for the A-dependence of ρ. An example of probability function ρ for the radius of the enhanced permeability zone in FIG. 29a is shown in FIG. 29c. Note that as the tolerable error is decreased, the function approaches the Dirac delta function located at r=1000 meters which is the actual radius of the enhanced permeability zone. With such an approach, the model computes the expected location and state of a reservoir and provides quantitative measures of the uncertainties in this prediction.

In this approach, the results of a Basin RTM simulation or of a reservoir simulation yields a set of M predicted variables Ω(=Ω₁,Ω₂Λ Ω_{M}) These include porosity, permeability and mineralogy, geochemical and thermal data, and fracture statistics from which the model calculates synthetic seismic well log and geochemical data. These predictions depend on A via the Basin RTM or reservoir simulator. Setting the average of the Ω to observed values O₁, O₂Λ O_{M} of these quantities yields constraints on ρ. Then maximizing S subject to these constraints (observations) yields ρ(A). With ρ(A), the model provides not only a prediction of the most likely values of the N As, but also of the variance in the As. Thereby, the model computes the variance in predicted reservoir characteristics. Through the integration of this approach with data/modeling technology, the model provides the risk analysis the industry needs to assess the economics of a given study area.

The model:

uses a more explicit formulation of this approach for basin modeling;

uses computationally efficient procedures for its application to well log and geochemical data analysis; and

integrates the results into an automated software.

The key is that the relation Ωᵢ(A) can only be obtained through simulations. To surmount the exceedingly long CPU time for each simulation, the model carries out selective simulations and then fits the Ωᵢ(A) to an analytic function by least square or other fitting. Next, the model finds the value of A minimizing the error and then refines the computation in the vicinity of the first approximate value minimizing the error.

The model is used to develop a computerized database on the Anadarko Basin. This laboratory basin is well-characterized via a rich and geographically distributed database that will be of great value to the industry and will provide a rigorous test of the technology. The richness and quality of the available data is illustrated by the fluid pressure as in FIG. 22. FIG. 22b shows the geographic/depth distribution of the points at which well-screened pre-production pressure data are available. These data were interpolated to illustrate the complexity of the OP and UP compartments in this basin.

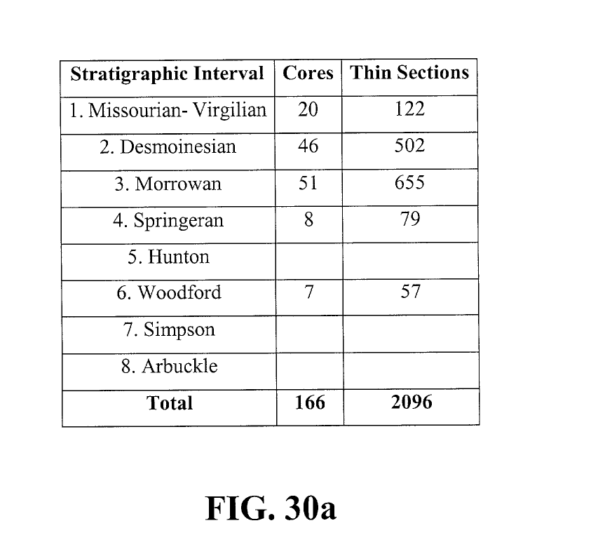

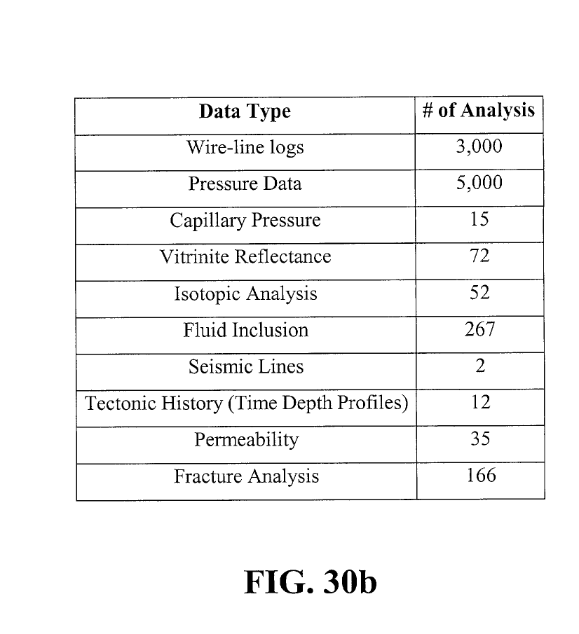

FIG. 30 summarizes the Anadarko Basin data presently available. Over 25 lithologies have been dated and described texturally and mineralogically. These data are complemented with additional seismic, well log, and other data.

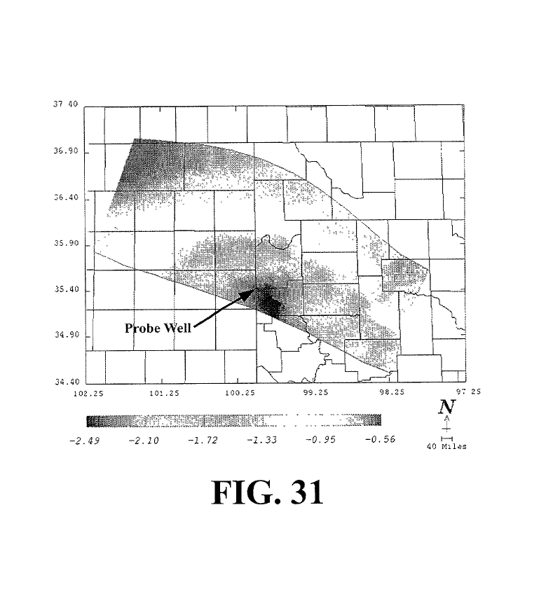

The tools used to browse the database include isosurfaces, cross-sections, and probes along any line. They are in the form of fluid/rock state variables as a function of depth or as synthetic logs for easy comparison with additional data available to the user. The 1 -D probe can be placed anywhere in the basin as suggested in FIG. 31.

The testing strategy divides the data into two subsets. Subset I is used as in part for the algorithm of FIG. 21. The remaining information, Subset II, is used to evaluate the accuracy of the predictions. A key question to be addressed in the tests is the amount of data required to obtain accurate predictions. Varying the size of Subset I (i.e., putting the remainder in Subset II) determines if the technology can be used in frontier vs. mature basins.

A second series of tests is used to determine the best mix of data for optimizing the accuracy of the predictions. This allows for guidelines to be prepared on the types of logs and geochemical data that give the most information with the minimum cost. Similar considerations are made regarding the geographic/depth data density.

Deep gas and by-passed petroleum in compartmented reservoirs (e.g., the Anadarko Basin) likely constitute the most promising natural gas resources for the United States as recent discoveries indicate. The model's current focus on such regimes addresses a number of critical research needs as these systems are still poorly understood from both the exploration and production standpoints. As the novel data/basin modeling interpretation greatly improves the ability to predict the location and characteristics of these reservoirs, the results assist in both improving energy independence and the efficiency with which these regimes are explored.

Risk assessment is a key aspect of the data/modeling integration strategy. There are uncertainties in the geological data needed for input to Basin RTM (notably overall tectonic, sedimentary, and basement heat or mass flux). This leads to uncertainties in data/modeling integration predictions. The model addresses this key issue with a novel information theory approach that automatically embeds risk assessment into data/modeling integration as an additional outerlooping in the flowchart of FIG. 21.

Formulas relate the sonic, resistivity, gamma ray, and neutral log signals to the texture (grain size, shape, packing and mineralogy, and porosity) and fluid properties (composition, intra-pore geometry, and saturation of each fluid phase). These formulas allow the creation of synthetic well logs to be used in the optimization algorithm of FIG. 21.

To predict petroleum composition and to take full advantage of the vitrinite and fluid inclusion data, the model uses a chemical kinetic model of kerogen and petroleum reaction kinetics. It includes over 20 species in a model of kerogen or oil to thermal breakdown products based on a chemical speciation/bond breaking approach similar to that developed for lignin kinetics. The model uses a hydrocarbon molecular structure/dynamics code to guide the macroscopic kinetic modeling.

To address the computational challenges of multi-phase (oil, water, gas) systems with many organic and inorganic components (≧20), the model uses a generalized multi-phase flow module. The new three-phase, N-component simulator is based on a new phase geometry dynamics model that accounts for the changing wetting and pore-scale geometry of the pore fluids. Published data on equations of state, relative permeability, and capillary pressure are used to calibrate the model.

The Anadarko Basin is so rich in deep and shallow-lying oil and gas in a variety of reservoirs (conventional, fracture-related, banded, and compartmented) that it serves as an excellent laboratory basin in light of the extensive available data. Integrating this database provides the industry with a very valuable basis for testing theories and models and yields a valuable guide for the future exploration and production of this acknowledged prospective area. Data available include seismic, well logs, fluid chemistry, core/thin section analysis and samples, vitrinite reflectance, fluid inclusion data (with over 20 identified organic and inorganic species), downhole temperature and pressure, and outcrop data. The data are formatted and integrated into a unified database.

To make these data convenient to use, the model uses a 3-D visualization tool based on an existing 3-D graphics package using AVS (used to generate FIGS. 8, 11, 22, and 23).

### Integrated Reservoir Simulation/Crosswell Tomography for CO₂ Geo-Sequestration Analysis

The present method integrates novel research on the physical chemistry of multi-phase flow with modem crosswell tomographic imaging, seismic velocity/attenuation formulas, information theory, and probability functionals to meet the practical challenges of monitoring and optimizing CO₂ sequestration and simultaneous enhanced petroleum recovery. The present methodology makes image interpretation much richer than classical methods as it allows predictions of the evolving state of porosity, fracturing, and permeability in addition to the geometry and fluid phase characteristics of the evolving CO₂ plume. The method provides a quantification of the uncertainty/risk in these predictions that is consistent with the given information (crosswell tomography, production history, well logs, core analysis, etc.) within the reservoir. The approach is robust to noise in the observed data making it an important advance in reservoir analysis.

The present approach is based on the following results:

A new multi-phase flow law that accounts for the changing wetting and intra-pore geometry (and associated hysteresis) of the fluid phases. This overcomes the weaknesses of other multi-phase models. The flow laws and related reservoir simulator describe CO₂ injection and simultaneous enhanced petroleum recovery with sufficient pore scale detail to calculate the seismic velocity and attenuation needed to interpret tomographic images.

Advanced formulas for the dependence of seismic wave speed and attenuation (as predicted by the new multi-phase flow model) on fluid phase geometry, fractures, and grain size, shape, mineralogy, and packing to achieve enhanced seismic image interpretation. These dependencies are not accounted for in a self-consistent and simultaneous manner in other seismic image interpretation approaches.

By integrating the seismic wave velocity and attenuation formulas with the multi-process reservoir simulator, an automated approach is obtained that is a qualitative improvement in both the interpretation of crosswell tomographic images of the CO₂ plume and other evolving repository features and that improves the accuracy of reservoir simulation. The reservoir model is the only one that can predict sufficient information to compute the seismic wave velocities and attentions and, thereby, achieve this integration.

The information theory-based approach for estimating the most probable reservoir state and associated risk allows for the automation of the delineation of reservoir size, shape, CO₂ plume characteristics, internal distribution of porosity, and multiphase flow properties, as well as integration of reservoir simulation and crosswell tomographic image interpretation.

A novel numerical algorithm for solving the inverse problem is a major improvement over simulated annealing and other procedures. The technique captures the 3-D complexity of a repository.

The availability of accurate predictive models and of techniques for monitoring the time-course of an injected waste plume is key to the evaluation of a strategy for CO₂ and other fluid waste disposal in geological repositories. The present method addresses both of these requirements using novel modeling and modern seismic imaging methods and integrates them via information theory for predicting and monitoring the time course for original and injected fluids. The technology can be used to optimize the injection process or to assess the economic viability of this disposal approach. The method combines new physical and chemical multi-phase modeling techniques, computational methods, information theory, and seismic data analysis to achieve a completely automated method. As such, the method is of great fundamental interest in delineating the dynamics of the subsurface and of great practical value in a variety of waste disposal and resource recovery applications.

Substantial potential exists for environmentally sound sequestration of CO₂ in geological formations with high matrix or vuggy porosity/permeability. These include depleted or producing oil and gas reservoirs and brine-filled formations. The widespread geographical distribution of such sites, and the possibility for simultaneous CO₂ sequestration and enhanced petroleum recovery, make this technology of great potential value.

Geological sequestration of CO₂ requires that the CO₂ be transported into the formation, displacing gas or liquid initially present, and trapping CO₂ in the formation for stable, long-term storage. A critical component of a storage strategy is to understand the migration and trapping characteristics of CO₂ and the displaced fluids. This is a multi-phase, porous medium, reaction-transport system. Modeling CO₂ migration and trapping requires a quantitative description of the associated reaction, transport, and mechanical processes from the pore to the field scale. The challenge is made even greater as much of the state of porosity, permeability, and other reservoir characteristics are only known statistically, implying the need for a reliable risk assessment approach.

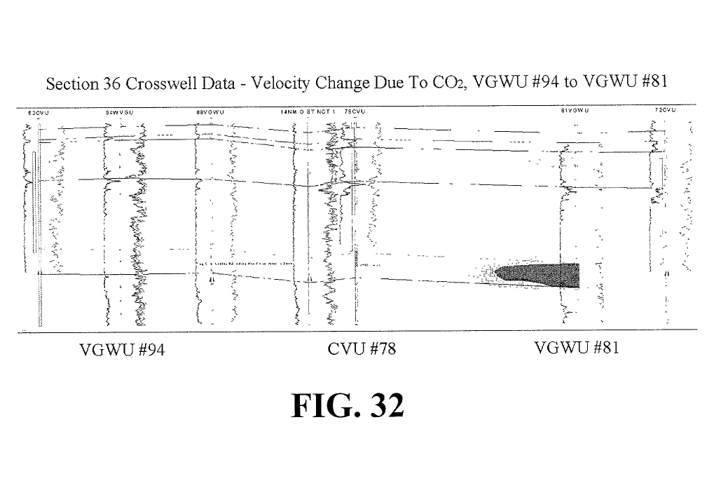

Crosswell tomography can delineate an image of the CO₂ plume (see FIG. 32). However, seismic wave speed and attenuation depend on many reservoir factors that can change during injection (porosity, pore fluid phase and configuration, grain size, shape, mineralogy, and packing and fracture network statistics). Thus an unambiguous delineation of the CO₂ plume, and not other changing reservoir characteristics induced by injection, requires additional information. The present method solves this noninvertability problem by integrating multiple process reservoir simulators with crosswell tomographic image interpretation.

To address these challenges to monitoring and optimizing the geological sequestration of CO₂, the present method:

(1) implements a new multi-phase flow law to account for the evolving pore-scale geometry and wetting of the fluid phases (to overcome the shortcomings of available reservoir simulators);

(2) uses improved seismic velocity/attenuation formulas and implements them into an automated seismic image interpretation algorithm;

(3) uses an information theory method to predict the most probable state and associated uncertainties in the distribution of reservoir characteristics;

(4) integrates the above three with crosswell tomographic imaging of the CO₂ plume; and

(5) is tested in a well-studied Vacuum Field.

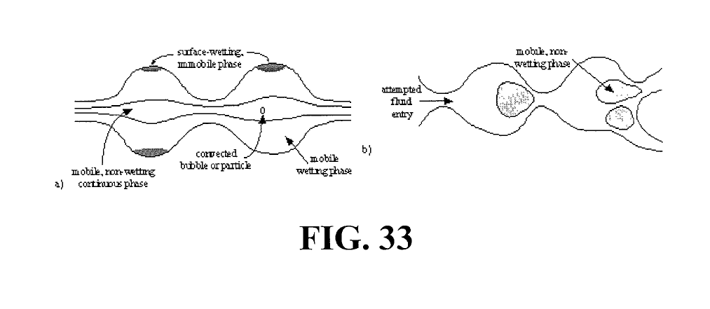

A severe limitation for both multi-phase flow modeling and tomographic image interpretation is the need for an understanding of the changing configuration of the fluid phases within a pore, vug, or fracture (see FIG. 33). Overall flow characteristics are strongly modified as a phase changes from a wetting configuration to a free-floating droplet. Furthermore, phases often change from droplets to a continuous geometry that spans many pores. This phase geometry dynamic changes the overall flow-through and, in turn, is changed by it. This phase geometry to overall flow coupling is not captured in available multi-phase models. These changing pore-scale phase geometries also modify the velocity and attenuation of a seismic wave. A new multi-phase flow model is developed for use in simulating CO₂ injection and to provide the seismic velocities and attentions needed for interpreting tomographic images. This new multi-phase model is integrated into the existing 3-D RTM reservoir simulator to predict all the local properties on which seismic velocities and attenuations depend. The latter include saturations, the geometry of the phases (gas, oil, brine, CO₂), the state of fractures and rock texture (grain size, shape, packing), and lithification/rock competency. The simulator is the only one with the comprehensiveness of RTM process and the full 3-D implementation required for this seismic image interpretation. This technology presents a more reliable and detailed interpretation of the seismic image, i.e., allowing one to discriminate the CO₂ plume and features such as a zone of fracturing from injection-induced stress changes.

Numerical models for multi-phase flow in porous media have been presented by various researchers based on finite difference and finite element methods. In parallel with the advances in computer hardware, the simulators have started to employ implicit numerical techniques with applications to miscible multi-phase flow problems. Newton-Raphson linearization appears to be the most popular technique in the solution of nonlinear algebraic equations which makes the need for fast, large-sparse-matrix solvers inevitable.

The similarity among these numerical models is the use of a generalized Darcy's law to approximate the averaged momentum balance equations for multiple fluid phases. There is a vast amount of experimental data on relative permeabilities and capillary pressure relations. In the absence of experimental data, expressions of Brooks and Carey and Van Genuchten are commonly used. However, because of the sensitivity of parameters to rock texture, and fluid configuration and properties, and hysteresis in the relations, a unified model has not been developed.

Hysteresis in the relative permeability and capillary pressure relations arise due to the changes in fluid configuration. Because the change in fluid configuration is not described by the classical variables in which the above models are based (saturations and fluid phase composition), additional empirical (and not self-consistently predicted) parameters are introduced to model the observed hysteresis.

To illustrate the relationship between the model completeness and hysteresis behavior, consider two variables X and Y evolving via dX/dt=F(X,Y) and dY/dt=G(X). The second equation can be solved in the form

$$Y = {Y}^{*} ( t ; X ) = Y ( 0 ) + {\int }_{0}^{t} ⅆ {t}^{′} G ( X ( {t}^{′} ) )$$

where Y^{*}(t;X) clearly depends on the history of X from an initial instant t=0 to the present time t. Combining these results, one obtains dX/dt=F(X,Y^{*}(t;X)). The memory in the right hand side of this equation is a consequence of the incompleteness of a theory cast only in X, omitting an explicit accounting of the Y dynamics. In the approach proposed here, fluid configuration modeling should be of the Markov type, i.e., at any time the rate of change of all variables only depends on the state of the system at that time and not on previous history. A complete multi-phase model must be based on a sufficiently complete set of descriptive variables and the Markov-type equations yielding their evolution.

A generalization of Darcy's law to multi-phase flow was suggested by Wyckoff and Botset and Muskat et al. Numerous attempts have been made to derive and improve it. Development of homogenization and volume averaging techniques improved our understanding of Darcy's law. Yuster was the first to introduce the cross permeability terms that accounts for viscous momentum transfer between fluid phases. Although there are a number of experimental studies, the cross-permeability-like terms in the theory are yet to be clearly understood. Another modification of Darcy's law was suggested for low velocity flow of a Newtonian fluid in a swelling porous medium with strong interactions between the solid and fluid phases.

Research on fluid flow laws and constitutive relations (relative permeability and capillary pressure) has been hampered by the absence of a complete set of variables to describe the micro-scale fluid configuration dynamics. The present method uses improved multi-phase flow laws and model parameters based on the introduction of wetting fractions (fractions of the pore surface wetted with different phases) and other variables, as well as equations for their evolution.

The coupling of multi-phase flow diagenesis and changes demands that flow and rock mechanics be simulated simultaneously. The 3-D simulator, Reservoir RTM, accounts for all such coupling.

The subsurface is only partially characterized through well log, seismic, surface, and production histories. What is needed is an objective formulation for integrating all these data into a statistical framework whereby uncertainties in the spatial distribution of fluids, hydrologic properties, and other factors can be estimated and the related uncertainties evaluated. The present method uses a rigorous information theory approach to assess this uncertainty. It obtains the probability for the least well constrained pre-CO₂-injection state of the repository. This allows it to both predict the likely consequence of the injection and to quantify the related risks.

Geostatistical methods are extensively used to construct the state of a reservoir. Traditional geostatistical methods utilizes the static data from core characterizations, well logs, seismic, or similar types of information. However, because the relation between production and monitoring well data (and other type of dynamic data) and reservoir state variables is quite complicated, traditional geostatistical approaches fail to integrate dynamic and static data. Two significant methods have been developed to integrate the dynamic flow of information from production and monitoring wells, and the static data. The goal of both methods is to minimize an “objective function” that is constructed to be a measure of error between observations and predictions. The multiple data sets are taken into consideration by introducing weighting factors for each data set. The first method (sequential self-calibration) defines a number of master points (which is less than the number of grid points on which the state of the reservoir is to be computed). Then a reservoir simulation is performed for an initial guess of the reservoir state variables that is obtained by the use of traditional geostatistical methods. The nonlinear equations resulting from the minimization of the objective function requires the calculation of derivatives (sensitivity coefficients) with respect to the reservoir state variables. The approximate derivatives are efficiently obtained by assuming that streamlines do not change because of the assumed small perturbations in the reservoir state variables. In summary, the sequential self-calibration method first upscales the reservoir using a multiple grid-type method and then uses stream line simulators to efficiently calculate the sensitivity coefficients. A difficulty in this procedure is that convergence to an acceptable answer is typically not monatomic (and is thereby slow and convergence is difficult to assess). The second method (gradual deformation) expresses the reservoir state as a weighted linear sum of the reservoir state at the previous iteration and two new independent states. The three weighting factors are determined by minimizing the objective function. The procedure is iterated using a Monte Carlo approach to generate new states. The great advance of the present approach over these methods is that (1) it directly solves a functional differential equation for the most probable reservoir state and (2) has a greatly accelerated numerical approach that makes realistic computations feasible.

The present method is based on an integrated study on multi-phase reservoir simulation and seismic image interpretation. It uses new physico-chemical flow laws and integrates them with advanced seismic imaging and probabilistic approaches to provide a complete CO₂ sequestration optimization and monitoring approach. The method provides tools (i.e., a sequestration simulator and enhanced image interpretation software) to optimize the injection of CO₂, and predict and monitor long-term CO₂ storage in geological formations.

A mathematical model describes the physics and chemistry of miscible displacement using a phase geometry dynamics approach. Strongly coupled RTM processes are now well-known to underlie multi-phase flow and other geological phenomena. The present comprehensive, 3-D fully coupled RTM model has the power to serve as a basis for a CO₂ sequestration simulator capable of predicting the effect of the CO₂ on diagenetic and mechanical processes that may change the porosity, permeability, and other repository characteristics.

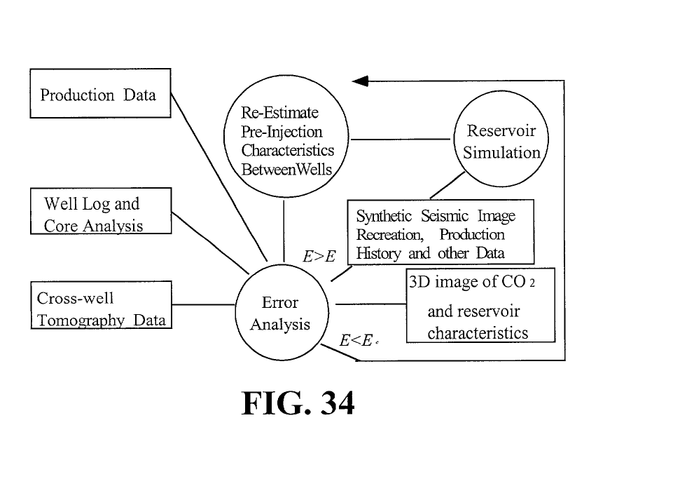

Data on CO₂ injection is gathered to test the integrated seismic imaging and reservoir simulation technologies. Data include well logs, downhole sampling, core analysis, seismic data, and production information. Formulas for the dependence of seismic velocity and attenuation on local reservoir factors are incorporated into the seismic interpretation algorithm. Factors accounted for include fluid phase geometry and wetting, rock texture, and fracture length/aperture/orientation statistics. The multi-phase flow model and reservoir RTM simulator uniquely provide the level of detail on these factors required for reliable seismic image interpretation of both the CO₂ plume and its effects on the repository lithologies and surrounding seals. The seismic formulas, artificial seismic image recreation, and information theory are integrated to yield enhanced interpretation of seismic images (the simulation-enhanced remote geophysics (SERG) technology). This novel approach builds on the simulation-enhanced fracture detection technology shown in FIG. 34 but brings unprecedented speed and accuracy to the invasion problem by directly solving functional differential equations for the most probable state and associated uncertainty.

The present method is tested in the Vacuum Field based on observations of CO₂ injection.

FIG. 33 suggests that the geometry of the fluid phases dictates the operating flow processes. To capture these processes, one should know the instantaneous configuration of each phase. In the present model, this configuration is described via a set of geometry variables. Let ξᵢ (i−1,2,Λ Nₚ) be the fraction of the pore surface wetted with phase i for a system with Nₚ fluid phases. Normalization implies

ξ₁+ξ₂+Λξ_{N}_{ₚ}=1. (2.1)

The saturations s₁, s₂, Λ S_{N}_{ₚ} are similarly normalized. For the ξ,s description to be “complete,” it should allow any phase to make a transition between the phase domain types suggested in FIG. 33.

First, consider a wetting phase (ζᵢ≠0). For ζᵢ near unity, phase i is assumed to be a supra-pore scale-continuous phase. For sᵢ,ξᵢ small, phase i is assumed to exist as a small, isolated, surface-attached immobile patch. Small ξᵢ=0,sᵢ-phases are droplets that tend to stream along with the immersion (majority) fluid(s). Finally, ξᵢ≈1, sᵢ small, phases constitute thin grain coatings that are not likely to flow. In this way, geometry and flow processes are related and the ξ,s-variables are used to interpolate between the associated flow behaviors.

Equations are developed for the ξᵢ evolution in response to variations in temperature and the composition of the pore fluids and solids in the form

$$\frac{ⅆ {ξ}_{i}}{ⅆ t} = {\sum }_{i \neq i} {W}_{{i}^{′} \to i} \qquad ( 2.2 )$$

where W_{i′→i} is the net rate of replacement of a unit i′-wetted patch with an i-patch. Chemical reaction rate theory suggests that the W_{i′→i} can be written

W_{i′→i}q_{i′i}[Q_{i′i}ξᵢ,αₗ−ξᵢα_{i′}] (2.3)

where αᵢ is an activity-like factor for phase i that depends on its composition and temperature; q_{i′i} and Q_{i′i} are rate and equilibrium constants. The q, Q, and α parameters depend on the mineralogy and microstructure of the pore surface. Equation (2.3) is generalized for the multi-component, miscible case.

The temporal evolution of the saturations follows from the conservation of mass. Each of the N components in the N_{ρ} fluid phases is characterized by its concentration c_{αi} (α=1,2,Λ N). The C_{αi} and C_{αi′} are related by partitioning laws. Overall conservation for the sum quantities s₁C_{α1}+s₂c_{α2}+Λ s_{N}_{_{ρ}}c_{αN}_{ₚ}, normalization for the saturations, and the partitioning laws are sufficient to fix the saturations and concentrations.

A multi-phase flow law is based on the concept of a balance of forces on each phase. The frictional drag force on phase i of viscosity ηᵢ is taken to be proportional to the difference between its velocity and that of the other phases. The net frictional drag force on a given phase is equated to a sum of forces associated with the gradient of pressure pᵢ of phase i, and capillary forces. Letting the matrix be labeled phase number 0, we write

$${η}_{i} φ {s}_{i} {\sum }_{{i}^{′} = 0}^{{N}_{p}} {Δ}_{{ii}^{′}} ( {\underline{v}}_{i} - {\underline{v}}_{{i}^{′}} ) = - {\sum }_{{i}^{′} = 0}^{{N}_{p}} {K}_{{ii}^{′}} ( \underline{∇} {p}_{i} + {\underline{Γ}}_{{ii}^{′}} + {ρ}_{1} \underline{g} ) . \qquad ( 2.4 )$$

The Kᵢᵢ, term represents the force on phase i due to its exposure to phase i′ even when their relative velocity is zero. Thus, the Kᵢ₀ term vanishes for non-wetting phases (ξᵢ=0). As ξᵢ→0, the explicit formulation is designed such that Kᵢ₀→0 as ξᵢ→0. While Pᵢ represents the pressure within phase i, ∇pᵢ+Γ_{ii′+}Pᵢg accounts for the net force on phase i due to its pressure gradient, capillary forces on i due to i′, and gravity (g being the gravitational acceleration vector and ρᵢ being the i-phase mass density). The capillary force vector Γ_{ii′} reflects the radius of curvature imposed by phase i′ on i and the nature of the i,i′ interfacial forces. Γᵢ₀ represents the capillary forces imposed due to the curvature of the solid matrix-fluid phase i interface. Γᵢ₀ increases in magnitude inversely with pore radius.

The essence of the model is that the parameters in equation (2.4) depend on phase geometry and, in turn, the dynamics of the latter depend on fluid pressure and composition. Thus

Δ_{ii′}−Δ_{ii′}(ξ,s,Θ)

K_{ii′}=K_{ii′}(ξ,s,Θ)

Γ_{ii′}=Γ_{ii′}(ξ,s,Θ,pᵢ,p_{i′}). (2.5)

Θ represents the texture (grain size, packing, shape, and mineralogy). In addition to ξ,Θ, and s, allow Γ_{ii′} to depend on p_{i′}, the pressure of the phases with which phase i interacts through the K_{ii′} term. Through the dependence of the Δ,Γ, K, the phase geometry to flow coupling is achieved.

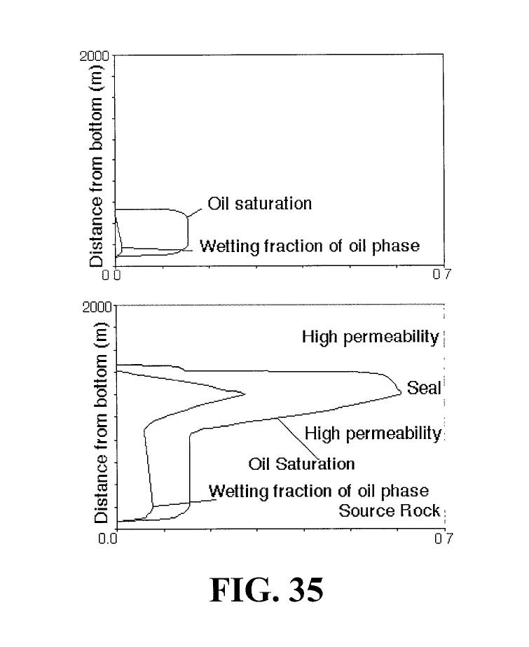

FIG. 35 illustrates an example of a geological time-scale simulation using the phase geometry model. In it, a source rock in the lower zone generates and expels oil. Note that the rising saturation front advances faster than the wetting front. The present method refines and calibrates this new flow law and implements it as a 3-D finite element simulator.

A comprehensive reaction, transport, mechanical model and 3-D finite element simulator includes diagenesis, multi-phase flow, rock deformation, fracturing, and heat transfer. The new multi-phase flow laws are implemented to test them in a more geologically complete context. The model allows investigation of CO₂-injection-induced fracturing or diagenesis to provide more data for interpreting the seismic images. The model also provides a grid adapted to the sedimentary layers. An example simulation is shown in FIG. 27.

The crosswell tomography method provides the resolution to image small changes in seismic velocity due to changes in pore fluid saturations such as the miscible CO₂ replacement of brine and oil. Crosswell seismic data acquisition requires that a source be placed in one well while recording seismic energy in another well. Seismic tomographic reconstruction and imaging enables one to define the velocity field and reflection image between the two wells. Typically three or more receiver wells are selected around the source well so that a quasi three-dimensional view of the reservoir is obtained. The first set of observations is generally done before CO₂ injection to obtain a baseline for comparison with later time-lapse repeat observations used to track the progress of the injected CO₂.

FIG. 33 shows a successful time-lapse crosswell seismic study that tracks CO₂ injected into the Upper San Andres reservoir in the Vacuum Field, New Mexico. The anomaly due to CO₂ in the Upper San Andres is found to cross downwards through a karst (or possibly fractures) from right-to-left. In addition, a larger and unexpected plume of CO₂ in the Lower San Andres was imaged. The CVUW #78 production well was deepened to produce this zone resulting in a production increase from 350 barrels-of-oil-per-day to over 1,000.

The Vacuum Field near Hobbs, New Mexico, is one of the most studied oil fields undergoing CO₂ flood EOR (enhanced oil recovery). Vacuum Field was discovered in 1929 with oil production starting in 1937. Water flood EOR commenced in the late 1960s followed by CO₂ flood EOR in 1985 beginning with East Vacuum Field. In the next few years new sections of Vacuum Field will be opened up to CO₂ flood EOR affording the opportunity to study CO₂ flow in a well-characterized reservoir environment.

The Permian age reservoirs called the San Andres and Grayburg are carbonates, primarily dolomites located in the depth interval 4200 to 4800 feet. Average porosity is 11.6% and average permeability is 22.3 millidarcies. The Reservoir Characterization Project utilized time-lapse 3-D, 3-component surface seismic data to attempt tracking CO₂ under varying reservoir pressure. The Project found shear-wave velocity best characterizes the reservoir's vuggy porosity and shear-wave anisotropy best delineates fracture systems opened by increased reservoir pressure due to CO₂ injection. However, no claim was made about tracking actual CO₂.

High-frequency crosswell seismology can also utilize both compressional and shear waves for delineating the porosity and fracture system between wells. However, time-lapse crosswell studies were made of the San Andres and Grayburg reservoirs in Vacuum Field at constant reservoir pressure. No significant shear-wave velocity variations were noted indicating that changes in effective pore pressure play an important part in the shear-wave response. On the other hand, small changes in compressional-wave velocity and amplitude were correlated to actual CO₂ and verified through drilling (see FIG. 33). Hence, crosswell seismic is recommended as the tool of choice for monitoring the flow of CO₂.

The crosswell studies in Vacuum Field to track CO₂ indicate that both compressional-wave velocity and attenuation are sensitive to the presence of CO₂. Compressional-wave velocity is determined through the measurement of event travel times, which can be successful even when signal-to-noise ratio is poor. On the other hand, attenuation measurements of event amplitudes requires the best signal-to-noise ratios. Hence, only one profile exists where time-lapse compressional-wave velocity and attenuation were found reliable for tracking CO₂ in the reservoir zone. In that case, both the compressional-wave velocity and attenuation time-lapse results were in agreement as to where CO₂ had traveled.

Crosswell seismic acquisition is isolated from surface cultural noise that negatively affects surface seismic data quality. However, wells actively being drilled near a crosswell seismic study (especially if drilling is within the reservoir at the time) will greatly compromise the signal-to-noise ratio. In fact, the signal-to-noise ratio may be so poor that even travel times cannot be selected making the data not usable. Hence, as a precaution, the drilling engineer should be notified in advance of the crosswell study to avoid simultaneous drilling of nearby wells.

These considerations illustrate both the feasibility of the crosswell approach and the difficulties with noise, fracturing, and localization of high permeability zones. This demonstrates the need for the present method's more comprehensive reservoir modeling and risk assessment.

Difficulties with seismic interpretation come from the many factors affecting wave velocity and attenuation:

matrix porosity and texture;

density and phases of pore- and fracture-filling fluids;

fracture length, aperture, and connectivity;

fracture orientation relative to the propagation direction;

fracture cement infilling volume, mineralogy, and texture; and

pressure and temperature.

What is needed for more accurate monitoring is formulas for these dependencies. The key to the success of this facet of the present method is that the pore-scale geometry of the fluids as well as the grain size and mineralogy, porosity, and other predictions of the RTM model provide the information needed to compute the velocities and attentions at all spatial points in the 3-D domain. As the velocities and attentions depend on so many variables (in addition to CO₂ fluid saturation), only the present method is comprehensive enough to attain unambiguous imaging of the CO₂ plume as well as possible changes in the reservoir induced by CO₂ injection. The present method uses improved seismic wave velocity and attenuation formulas so as to be compatible with the phase geometry model.

Biot's theory of wave propagation in saturated porous media has been the basis of many velocity and attenuation analyses. Biot's theory is an extension of a poroelasticity theory developed earlier. Biot predicted the presence of two compressional and one rotational wave in a porous medium saturated by a single fluid phase. Plona was the first to experimentally observe the second compressional wave. In the case of multi-phase saturated porous media, the general trend is to extend Biot's formulation developed for saturated media by replacing model parameters with ones modified for the fluid-fluid or fluid-gas mixtures. This approach results in two compressional waves and has been shown to be successful in predicting the first compressional and rotational wave velocities for practical purposes. Brutsaert, who extended Biot's theory, appears to be the first to predict three compressional waves in two-phase saturated porous media. The third compressional wave was also predicted by Garg and Nayfeh and Santos et al. Tuncay and Corapcioglu derived the governing equations and constitutive relations of fractured porous media saturated by two compressible Newtonian fluids by employing the volume averaging technique. In the case of fractured porous media, Tuncay and Corapcioglu showed the existence of four compressional and one rotational waves. The first and third compressional waves are analogous to the compressional waves in Biot's theory. The second compressional wave arises because of fractures, whereas the fourth compressional wave is associated with the capillary pressure.

The challenge of interpreting seismic (and other remote geophysical) images is their non-unique relation to the distribution in space of the many factors that affect wave velocity and attenuation. However, much information about the state of a reservoir exists in the other data (production history, well logs, cores, fluid samples, surface geology) available to a CO₂ sequestration team. The present approach (1) minimizes interpretation errors by automating the use of all these data to estimate the most likely value of the uncertain reservoir parameters; and (2) uses information theory to assess the uncertainties (and associated risk) in the reservoir parameters so determined.

The present reservoir simulator may be implemented in an iterative computer code as suggested in FIG. 34. Parameters that are key to the predictions yet are less well-known are estimated by minimizing an “error” that measures the difference between (1) the actual seismic (and other) data and (2) that predicted by the reservoir simulator. A synthetic seismic program and the seismic velocity and attenuation formulas are used to create the reservoir simulator-predicted seismic signal. This error is minimized by using a conjugate gradient or other approach to estimate the least well-constrained parameters. Examples of reservoir parameters to be estimated in this way are those fixing the spatial distribution of reservoir characteristics or oil saturation between well-control points.

This SERG algorithm provides an advanced seismic image interpretation methodology. Classical seismic image interpretation is done using geological intuition and by discerning patterns in the data to delineate faults, formation contacts, or depositional environments. The present approach integrates the physics and chemistry in the RTM simulator and the seismic data to interpolate between wells. This approach has two advantages: (1) it provides wave properties at all spatial points within the reservoir and (2) it uses basic laws of physics and chemistry. This gives geoscientist a powerful tool for the analysis of remote geophysical data.

This advanced interpretation technology is applied to remotely detect fractures in tight reservoirs. The present method adds the important aspect of risk assessment and the special challenge of two and three phase flow expected in the CO₂ sequestration problem.

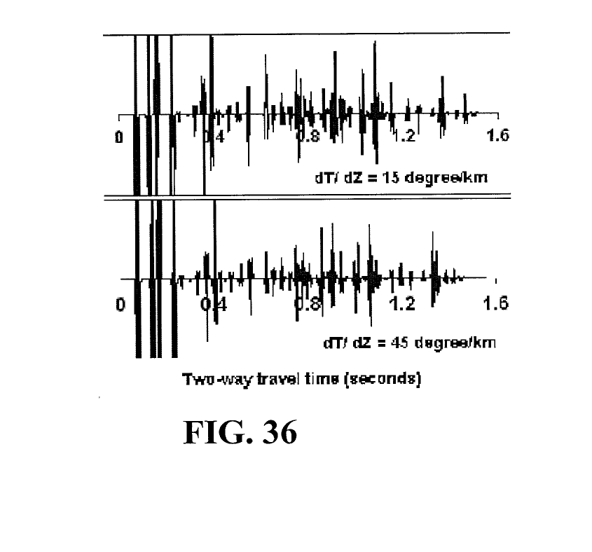

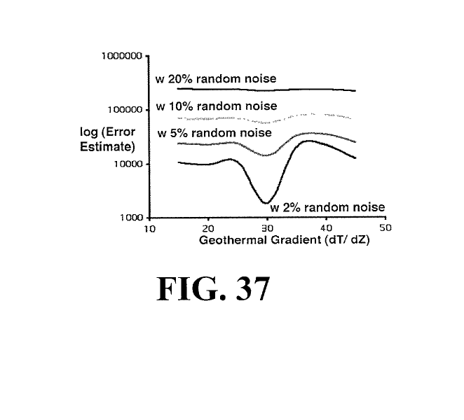

A result of a simulation-enhanced seismic image interpretation approach is seen in FIGS. 27, 36, and 37. FIG. 27 shows porosity and compressional seismic wave velocity as predicted by the Basin RTM program for a 25.9 million year simulated evolution. Such profiles of predicted wave velocity (and attenuation) are used to construct synthetic seismic signals as seen in FIG. 36. Note that the two cases in FIG. 36 differ only in the geothermal gradient assumed present during basin evolution. FIG. 37 shows the error (the difference between the predicted and observed signals) as a function of geothermal gradient (for illustrative purposes here, the “observed” signal is the 30° C./ km simulation).

The error shown in FIG. 37 is computed as a quadratic measure:

$$E = {\sum }_{i = 1}^{M} {( {Ω}_{i} - {O}_{i} )}^{2} . \qquad ( 2.6 )$$

Here Oᵢ and Ωᵢ are members of a set of M observed and simulated values of quantities characterizing the seismic signal (arrival times, amplitudes, or polarizations of a one, two, or three dimensional data set). The predicted attributes Ωᵢ depend on the values of the least well-constrained reservoir parameters (such as the geothermal gradient or overall tectonics present millions of years ago). Two different sets of Ω, O are shown in FIG. 37 that are from the same study but involve different seismic attributes (raw signal and a correlation function). These examples show that the error can have multiple minima so that (1) care must be taken to find the global minimum and (2) one must develop the most reliable error measure. Another concern is the robustness of the method to the presence of noise in the observed seismic signal. These issues are investigated here in the context of CO₂ sequestration.

A major feature of the present method is an algorithm for computing the most probable reservoirs state and associated risk assessment. To quantify risk one must obtain an objective methodology for assigning a probability to the choice of the least well-controlled variables. The present approach is based on the information theory but differs from other applications in geostatistics in that the approach integrates it with RTM simulation as follows.

The following is a description of how the present method computes the probability of reservoir state. The starting point is the probability ρ[Ψ] for continuous variable(s) Ψ [symbol] specifying the spatial [symbol] distribution of properties of the preproduction fluid/rock system. Information theory is generalized as follows. The entropy S is given as a type of integral of ρlnρ over all possible states Ψ [symbol] In the present problem, Ψ [symbol] is a continuous infinity of values, one for each spatial point \ddot{r}. Thus, S is a “functional integral” designated:

$$S = - {S}_{Ψ} ρ l n ρ \qquad ( 2.7 )$$

where S implies functional integration. In the spirit of information theory, ρ is the probability functional that maximizes S subject to normalization,

$${S}_{Ψ} ρ = 1. \qquad ( 2.8 )$$

Let O (={O₁,O₂,Δ_{M}}) be a set of M observations (i.e., discretized seismic, well data, or production history information). For simplicity here, assume one type of data. Let Ωλ(λ=1,2,Λ M) be a set of values corresponding to the 0_{λ} but as predicted by a reservoir or other model. The Ω_{λ} are functionals of the spatial distribution of reservoir characteristics, i.e., Ω=Ω[Ψ]. Define the error E[Ψ] via

$$E [ Ψ ] = {\sum }_{λ = 1}^{M} {( {Ω}_{λ} [ Ψ ] - {O}_{λ} )}^{2} . \qquad ( 2.9 )$$

Constrain ρ by requiring that E have a specified ensemble average value, E^{*}, estimated from an analysis of errors in the reservoir model and observations; thus,

$${S}_{Ψ} E [ Ψ ] ρ [ Ψ ] = {E}^{*} . \qquad ( 2.10 )$$

also constrain the spatial scale on which Ψ can vary. In a sense, seek the probability density ρ for an upscaled (locally spatially averaged) Ψ. To do so, use a homogenization constraint denoted C₂: the latter provides the preferred weighting of ρ towards smoother Ψ [symbol] so as to make the predicted most probable state consistent with what was used for upscaled in the reservoir model. Introducing Lagrange multipliers β₀,β₁,β₂ gives:

λnρ[Ψ]=−β₀−β₁E[Ψ]−β₂C₂[Ψ]. (2.11)

A central objective of the SERG approach is to compute the most probable distribution, i.e., that for which the functional derivative δρ/δΨ [symbol] vanishes. This most probable state satisfies

$$\frac{δ E}{δ Ψ {( r )}^{M}} + λ \frac{δ {C}_{2}}{δΨ {( r )}^{ρ}} = 0 \qquad ( 2.12 )$$

where λ=β₂/β₁. The higher the spatial scale of upscaled most probable state sought, the larger the λ chosen. Without the λ-term and with coarse spatial resolution of the known data, there is an uncountable number of distributions Ψ [symbol] that minimize E[Ψ], i.e., for which δE/δΨ=0.

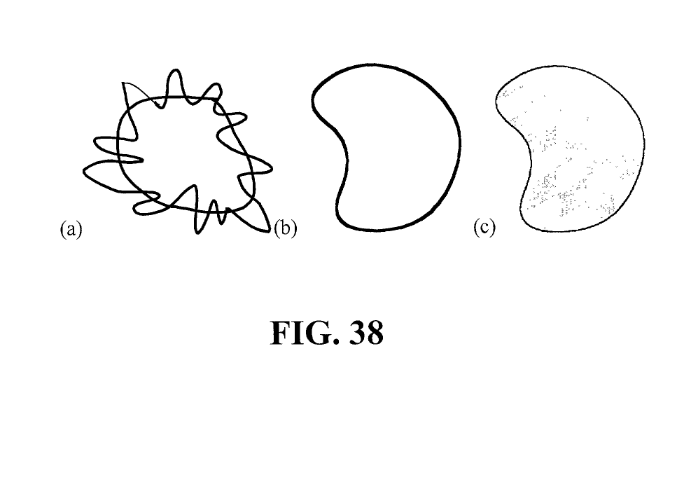

In this family of solutions, there are members such as suggested in FIG. 38a or others corresponding to a short scale mosaic of variations in Ψ [symbol] as suggested in FIG. 38. Thus the inclusion of the C₂ term filters the ensemble to favor smoother Ψ-distributions. This is a practical consideration as only an overall resolution of the Ψ [symbol] delineation problem is usually required for petroleum E&P applications. Finally, the parameter β₀ is determined from normalization in terms of β₁ and β₂, whereas β₁ and β₂ follow from the constraints from E and C₂.

Uncertainty in the most probable state can be estimated. Let Ψ^{m} [symbol] be the most probable state of the system (i.e. a solution of equation (2.16)). Introduce an uncertainty measure u via

$${V}_{T} {u}^{2} = {S}_{Ψ} ρ [ Ψ ] \int {ⅆ}^{3} r {\{ Ψ {( r )}^{M} - {Ψ}^{m} {( r )}^{M} \}}^{2} \qquad ( 2.16 )$$

where V_{T} is the total volume of the system. With this definition, u^{½} is a RMS uncertainty in Ψ about its most probable distribution Ψ^{m}. u is expected to increase as the spatial coverage and accuracy of the observed data O degrades.

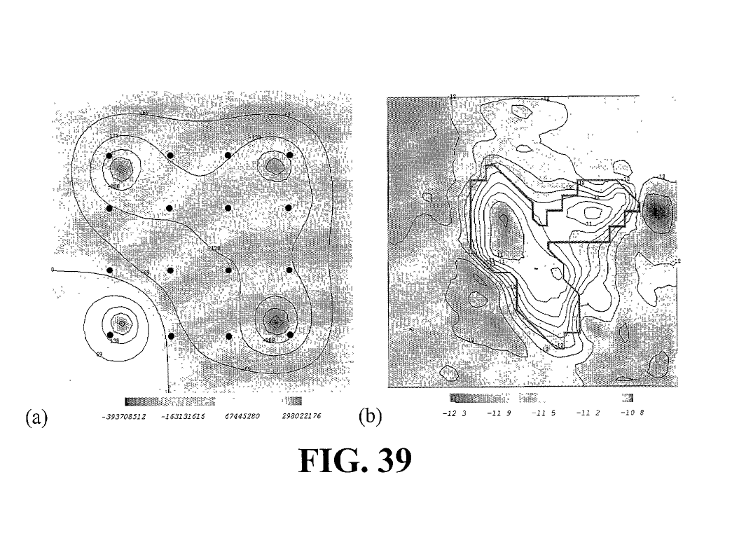

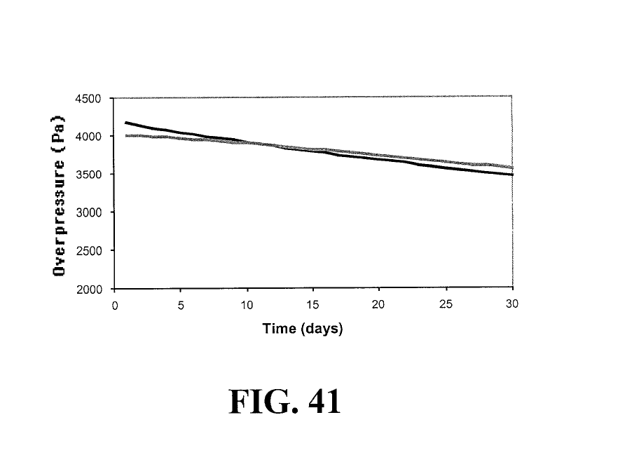

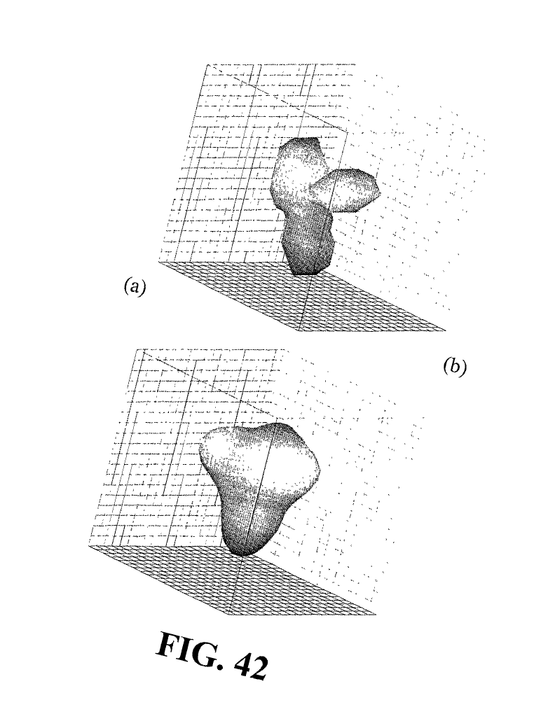

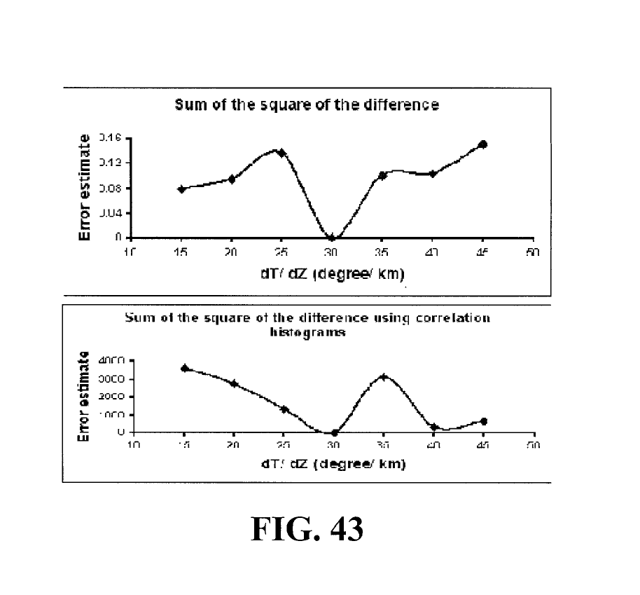

Results of the information theory/SERG approach are shown in FIGS. 39 through 42. FIG. 22 shows an application for a case wherein the geometry of the Super-K (anomalously high permeability) zone is constrained to be circular and the information theory is used to determine the permeability and radius of this circular zone. This simplified study is used to show the relationship between the reduced function space and a complete analysis of the full probability distribution.

An important feature of the approach is that it can integrate multiple types of data (seismic, well logs, production history) or data of various quality (old versus modern production history). To do so, introduce an error E₍ₖ₎ for each of the Nₑ data types (k=1,2,Λ Nₑ). In analogy with equation (2.14), write

$${E}_{( k )} = {\sum }_{i = 1}^{{N}_{ch 1}} {( {Ω}_{( k ) i} - {O}_{( k ) i} )}^{2} \qquad ( 2.14 )$$

where Ω₍ₖ₎ᵢ is the i-th data of the k-th set (i=1,2,Λ N₍ₖ₎) . Again, one can impose the constraints

$${S}_{Ψ} ρ {E}_{( k )} = {E}_{( k )}^{*} \qquad ( 2.15 )$$

for estimated error E₍ₖ₎.

The SERG software is an implementation of the above information theory formulation. The data types (Ω₍ₖ₎,O₍ₖ₎) include production history, seismic, core analysis, and well logs. The functional dependence of the Ω's on reservoir state is computed via the reservoir simulator. The most probable state is computed by solving the functional differential equation (2.14) generalized for multiple data sets and state variables. The computational algorithms, efficient evaluation of uncertainty, and parallel computing techniques make SERG a major step forward in history matching and crosswell tomographic image interpretation.

SERG rests on a new information theory approach for determining the most probable state of a reservoir and the associated uncertainty. Quantifying the state of the subsurface provides a challenge for the petroleum industry:

available information consists of mixed data types and quality and with different and often sparse spatial or temporal coverage;

the overall shape and location of a reservoir and its internal state (permeability and porosity distribution and reserves in place) are often uncertain;

there are many uncertainties about the preproduction reservoir state; and

while there is often a great quantity of data available, their use in limiting the uncertain geological and engineering parameters is subject to interpretation rather than being directly usable in a computer automatable procedure.

Data collected provide all the information needed for testing the SERG approach in the Vacuum Field. The data are used in three ways as follows. (1) Well log, core analysis, formation tops, and CO₂ injection data are used to run the simulator and compare the results with data from monitoring wells and preliminary seismic image interpretation. (2) The seismic image interpretation enhancement technique of FIG. 34 is tested. Predicted spatial distributions of reservoir characteristics are compared with data from well-control points not used in the error minimization of FIG. 34. The basin boundary history parameters (basement heat flux, overall tectonics, etc.) are fixed while in a purely reservoir simulation (engineering) approach, a more determined parameter specifying the location, shape, and characteristics of nonuniformities in the reservoir formations is used. (3) A complete SERG test is carried out in the Vacuum Field. Predicted best values of reservoir characteristics and uncertainties in them are compared to data from well-control points not used in the SERG simulations. The “convergence” of the procedure, i.e., do SERG predictions improve and uncertainties decrease as more and more data on the field are used?, is investigated. It is expected that as more data are used the uncertainty should decrease.

The results of all tests are synthesized and evaluated for success or failure. Quantitative measures of success are the model-predicted or seismic imaged geometry of the CO₂ plume at various times during injection and the measured composition and phase of fluids observed at monitoring wells. The observed downhole temperature variations are also used.

As experience in the Vacuum Field suggests, coordinated EOR and CO₂ sequestration could have great potential in partially depleted oil fields. However, the technology could also be used to assess, optimize, and monitor CO₂ injection in other types of formations. For example, one attractive possibility is the underpressured (UP) compartment. In these systems, the natural UP inhibits CO₂ escape and thereby is attractive in that such UP compartments have existed stably over hundreds of millions of years.

Compartments are found in sedimentary basins throughout the world. Such domains of rock, typically with abnormal fluid pressures, have been recognized for many years in the petroleum industry. Powley and Bradley have given evidence that sedimentary basins are typically divided into a boxwork of compartments each of which are bounded on top, bottom, and sides by seals. A number of compartments have been carefully examined in depth.

UP compartments offer the following desirable waste storage features.

The seals that bound them have existed over geologic time and therefore likely have some mechanism to heal themselves once breached, making them stable to tectonic and other natural disturbances.

Compartments typically exist below 2.5 kilometers, far from the accessible environment.

Because of the UP, even improperly cemented injection wells or unidentified abandoned wells will not provide avenues of fluid escape to overlying, normally pressured strata.

They may be monitored periodically (using petroleum industry-standard techniques) to assess changes in pressure, fluid composition, and other parameters, permitting evaluation of predictive models and modification of the injection strategy as data are accumulated.

The chemistry of the injected CO₂-rich fluids and formation mineralogy could be chosen such that, upon interaction, new mineralization will result that incorporates CO₂ and other waste chemical species (i.e., H₂S, SO₂, NO₂).

The widespread existence of UP compartments will minimize long distance waste transportation.

The present method evaluates the UP CO₂ repository concept and provides tools to evaluate likely compartments and optimize their usage. No other tools of this type are presently available.

The Anadarko Basin is perhaps the best example of a UP compartment-rich basin. Using quality-screened downhole pressure data gathered, the 3-D structure of Anadarko Basin compartmentation has been analyzed. As seen in FIG. 22, there are large regions of underpressure (UP) and many smaller-scale abnormally pressured zones as well. This and other data sources provide the kind of data to illustrate UP compartments.

A potential natural underpressured CO₂ field, accurately characterized by wells patterned on a one-mile grid, is estimated to span 5.5 million acres. It is composed of strongly UP limestones, dolostones, and shales. It has been estimated that each well has a potential waste storage capacity of up to 2×10⁶ barrels. Thus, the potential capacity for CO₂ storage is impressive.

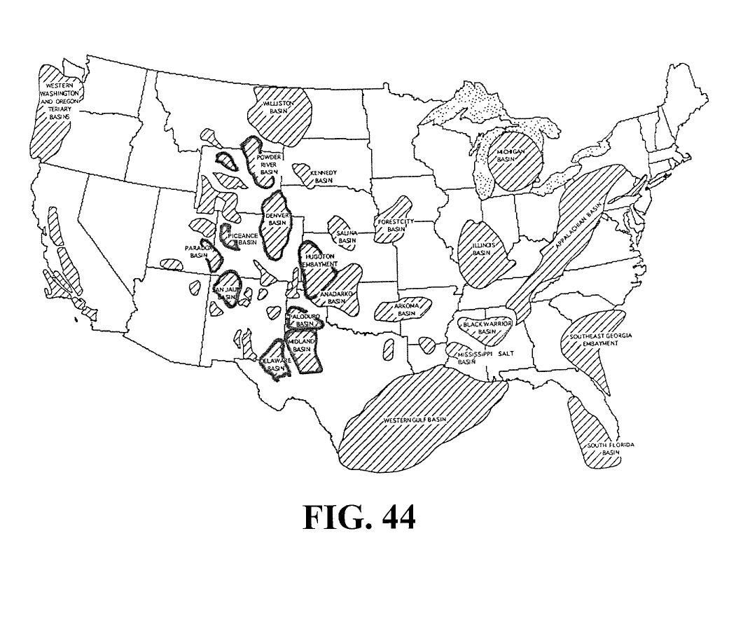

The potential for CO₂ sequestration in UP compartments of the Lower 48 states is suggested in FIG. 44 by their geographic distribution. This survey is likely just a fraction of the actual number of UP compartmented areas. Indeed, the U.S. coverage is quite complete and hence long-distance transport could be minimized. This situation is likely true worldwide also.

Three basic market segments are readily identified as possible targets for commercial application. Although not entirely independent of each other these markets are (1) oil industry, (2) environmental industry, and (3) industries involved with the localized emission of green house gases. The common thread among these markets is the need to track fluids in the subsurface over space and time.

Several aspects of the oil industry may be addressed by this technology: (a) time-lapse production of oil fields for improved performance; (b) monitoring of enhanced-oil-production using injected fluids such as CO₂; (c) reduced green house gas emissions at localized well sites; and (d) reduction in green house gases produced by wide-spread use of petroleum.

The objective of time-lapse production of oil fields is to produce the most oil from a reservoir over its lifetime using the fewest number of wells. Monitoring techniques such as time-lapse 3-D surface seismic and high-resolution crosswell seismology are good indicators of the current state of the reservoir. But these data along with production information need to be incorporated into a physico-chemical modeling approach that will enable reservoir predictions and the implied strategies. Only with the advent of time-lapse monitoring of a reservoir in recent years has this synergy with modeling become more feasible.

Enhanced oil recovery by injecting fluids into a reservoir can be a costly prospect resulting in millions of spent dollars. It is important to know where the injected fluid and petroleum migrate to optimize the location of injection and producing wells. Recovery and reuse of the injected fluids and depth are important cost reduction issues.

Some oil and gas wells are located where the gas cannot be separated and piped to a processing plant. Hence, the oil goes unproduced as a resource. An alternative to a pipeline would be the re-injection of the potential greenhouse gas back into a reservoir where it becomes geologically sequestered. This appears to be of potential great importance to the oil industry in the coming decade as regulations on greenhouse gas release become stricter.

The wide spread use of petroleum products results in the emission of greenhouse gases over large areas. Geological sequestration has been identified as a potential method for addressing this problem. However, before geological sequestration of these gases may occur, methods for their capture and injection must first be addressed. Hence, this application is a future potential market for this technology.

In addition to the greenhouse gas issue already addressed, the environmental industry also deals with near-surface contamination of ground water systems due to injection wells and leaks at disposal sites. For this issue the capability provided by the physico-chemical modeling for predicting fluid flow integrated with advances in near-surface, high-frequency seismic imaging provide a remediation and monitoring technology.

Certain industries release greenhouse gases that, unlike automobile exhaust, can be easily captured at the source and geologically sequestered in a nearby subsurface repository. As with the previous two industries, the tracking and prediction of fluid movement must be carried out to insure its long-term containment.

Advanced reservoir models, multi-phase flow, and numerical algorithms are integrated with crosswell seismic and information theory techniques to arrive at a powerful technology for predicting, optimizing, and monitoring the sequestration of CO₂ in geological formations. The approach involves the use of new multi-phase flow laws and a simulator that allows for an accounting of changing wetting and hysteresis not captured by other reservoir simulators. It also uses this simulation technology to improve the interpretation of seismic images through new velocity and attenuation formulas and an information theory/probability functional approach to automate the interpretation. The technology uses information theory to assess for risk. The method uses multi-phase flow laws and simulation, seismic wave velocity, and attenuation formulae and information theory software. Simulations using classic reservoir models are used to provide a basis of comparison. The reservoir simulation/seismic image interpretation technology is tested in the Vacuum Field.

The phase geometry dynamics model is extended, calibrated, and tested. The reservoir simulator is modified to accept the new phenomenology. The seismic velocity/attenuation formulas are recast in terms of the variables of the phase geometry dynamics model and the rock characteristics parameters (grain size, shape, packing, and mineralology, fracture statistics, etc.) predicted by the multi-process reservoir simulator.

### Demonstrating an Automated Field Development and Management Approach

### Integrated Reservoir Simulation/Data/Risk Assessment

Most reservoirs are geometrically complex and have internal compartmentation or super-K zones; many are at stress and fluid pressure conditions that make them vulnerable to pore collapse or fracture closure. This often leads to by-passed petroleum and reservoir damage. The present technology gives quantitative information about the subsurface needed to address these field development and management (FDM) challenges. The technology is a major advance over presently used history matching or seismic interpretation procedures due to computer automation and advanced algorithms. The FDM software yields (1) the most probable state (spatial distribution of permeability, porosity, oil saturation, stress, and fractures across a reservoir), (2) the optimal future production strategy, and (3) associated risks in these predictions. Thus FDM provides a next-generation field development and management technology. FDM is demonstrated in a Permian Basin field; the associated reservoirs are complex, ample data are available, and traditional history matching has not proven to be an adequate field management technology.

FDM integrates reservoir simulation with data through a novel information theory approach. FDM input includes production history, seismic, well log, and core characterization. FDM output is an ever-refined quantitative picture of the geometry, compartmentation, fracturing, matrix properties, and resources remaining in place. All data processing and risk assessment are fully computer-automated and integrated to achieve FDM's unprecedented accuracy, efficiency, and comprehensiveness.

The capability to integrate all or some of the data noted above gives FDM a great advantage over presently used history matching approaches. The unique set of three dimensional, multiple reaction, transport, mechanical process reservoir simulators makes it possible to integrate input data. This distinguishes our approach from other technologies. The difference between the synthetic (simulated) and observed data is used via information theory to arrive at the most probable state of a reservoir. The information theory/reservoir simulation software provides an assessment of risk/uncertainty in the present reservoir state and for future field management. Several major advances in FDM over classic history matching include new computational techniques and concepts that make the construction of the preproduction state and associated uncertainty feasible on available hardware. The integration of a wide spectrum of data types and qualities is made possible by the uniquely comprehensive set of RTM processes implemented in FDM. This allows FDM to integrate seismic, well log, and other data with historical production information. FDM brings unprecedented efficiency and risk control to the industry, helping the U.S. to achieve greater fossil fuel independence.

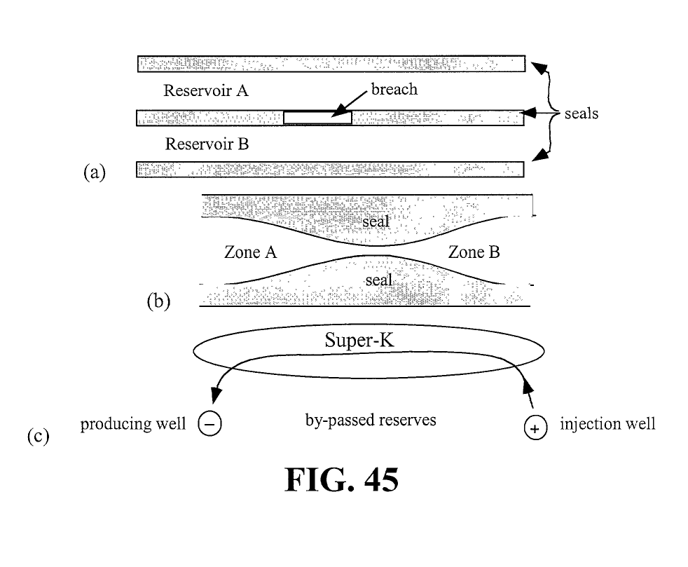

The present technology is a revolutionary automated procedure implemented in computer software for optimizing the production of U.S. reserves. The technology minimizes losses due to by-passed reserves, formation damage, drilling costs, and excessive water (vs. petroleum) production. Such problems arise in both high and low matrix permeability systems and commonly occur in cases where reservoirs are compartmented or contain zones of super-K (i.e., regions of karst or wide-aperture, connected fractures—leading to anomalously high local permeability). Typical situations are shown in FIG. 45.

An approach to such systems must be based on a quantified characterization of the reservoir away from the wellbore and down from the surface. The technology incorporates the following:

production history, well log, seismic, and other data;

estimation of uncertainties and risk in next well citing and production strategy;

and

available basin and reservoir simulators.

FDM integrates all the above in one automated procedure that yields a continuously updated forecast and strategy for the future development and production of a field. It achieves this through software that integrates reservoir simulation, data, and information theory.

In the cases shown in FIG. 45, there are difficulties in placing wells and planning the best production rates from existing wells to minimize by-passed reserves and excessive water cuts. The key to making successful decisions is quantifying the geometry of reservoir connectivity or compartmentation. The technology places quantitative limits on the location, shape, and extent of the zones of super-K or connectivity to other reservoirs or parts of the same, multi-lobed reservoir.

Information theory is used to provide a mathematical framework for assessing risk. Information theory software is used to integrate quantitative reservoir simulators with the available field data. The FDM software allows one to:

use field data of various types and quality;

integrate the latest advances in reservoir or basin modeling/simulation into production planning and reserve assessment;

predict the quantitative state (distribution of porosity, permeability, stress, reserves in place) across the system;

place quantitative bounds on all uncertainties involved in the predictions/strategies; and

carry out all the above in one automated procedure.

The FDM technology will improve the industry's ability to develop known fields and identify new ones by use of all the available seismic, well log, production history, and other observations. In summary, FDM is a shell program based on information theory that is used to run reservoir simulators, synthetic, seismic, or well log programs and utilize a variety of field data types.

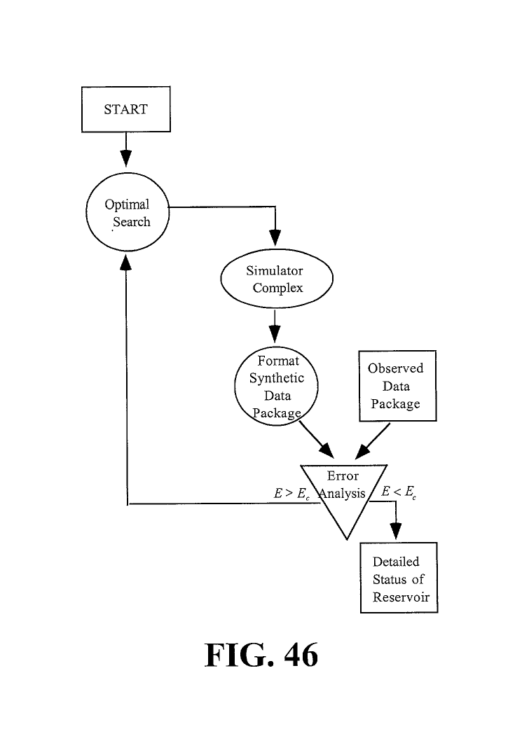

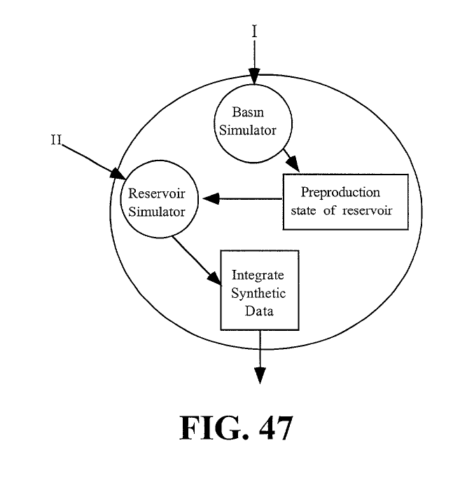

FDM has the flexibility to incorporate all or some of the following data: production history, seismic, well log, fluid inclusion, pore fluid composition and pressure, temperature, vitrinite reflectance, core characterizations, stress and fracture information. The approach overcomes the ambiguity in other approaches that attempt to directly use seismic or well log data to determine fluid/rock state. The FDM approach is based on unique multi-process reservoir simulators that allow FDM to use advanced physical and chemical equations that are based on the unambiguous determination of seismic and well log data from fluid/rock state. FDM also uses a new information theory method for finding the most probable state and associated uncertainty. It incorporates the logic of a history matching algorithm as suggested in FIGS. 46 and 47 except that it achieves great efficiency by directly determining the most probable state (e.g., spatial distribution of permeability, fractures, remaining reserves, etc.) and associated uncertainty. All the aforementioned FDM input data is introduced through an error measure that is used to constrain the probability of the reservoir state.

The FDM methodology differs from previous methodologies as follows:

A self-consistent method is used to relate the degree and method of upscaling in the reservoir simulator and in defining the spatial scale on which the most probable reservoir state is obtained.

The number of sensitivity coefficient calculations is greatly reduced, increasing with the number (N) of grid nodes on which the most probable reservoir state is obtained; in contrast, the number of these coefficients increases as (N²) for the other methods.

The core and other type of data are more directly imposed on the most probable reservoir state in the FDM method.

The types of reaction and transport processes accounted for in the reservoir simulators make it possible to construct an objective (error) function using synthetic seismic, well log, and production data.

The error function in the FDM computations decreases monotonically with the number of iterations assuming faster and unambiguous convergence to the most probable reservoir stated in the FDM method.

FDM is written in a very general way so that it is not restricted to reservoir simulators with simplified physics (e.g., streamline methods). Fully coupled multi-phase flow, fracture dynamics, formation damage, and other processes are used under FDM.

In summary, the FDM approach brings greater efficiency, accuracy, and reliability in determining the most probable reservoir state.

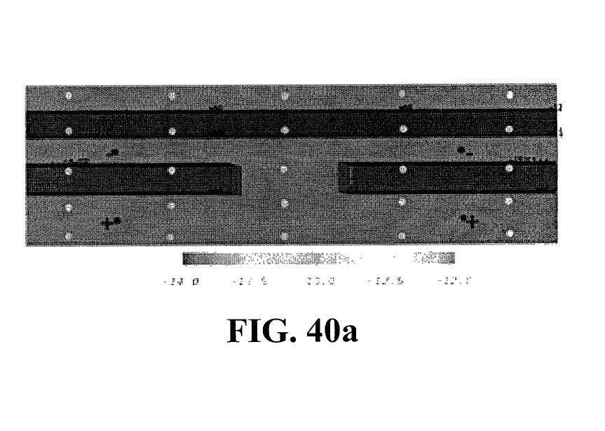

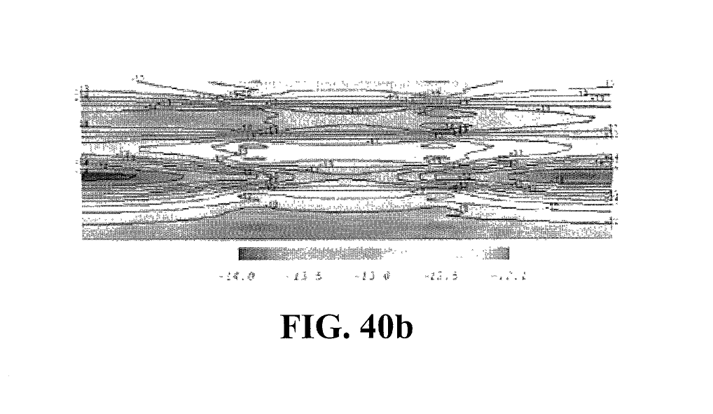

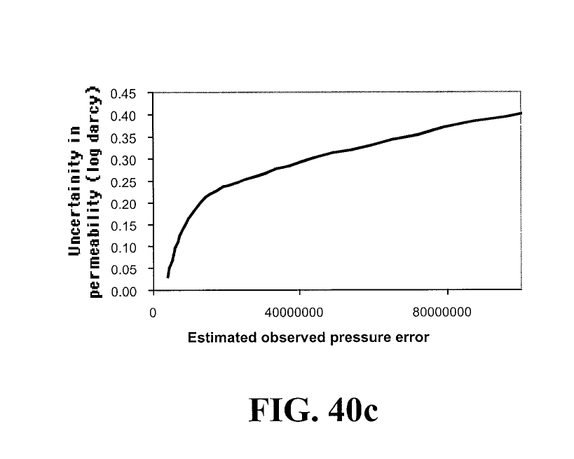

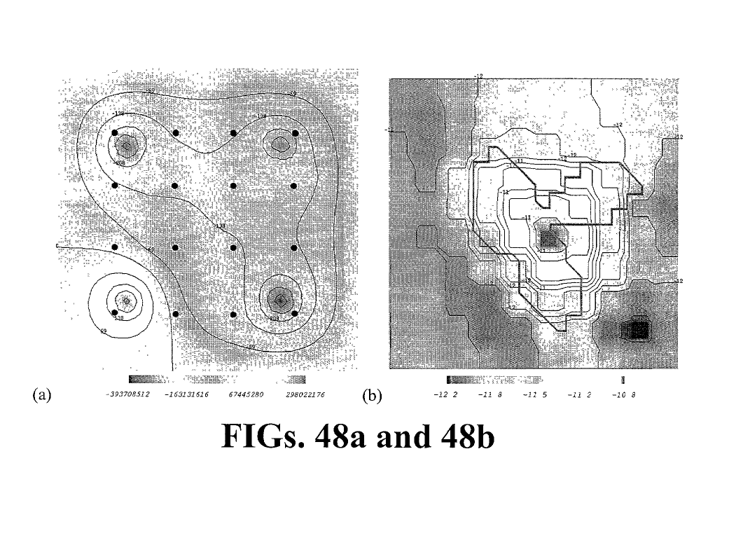

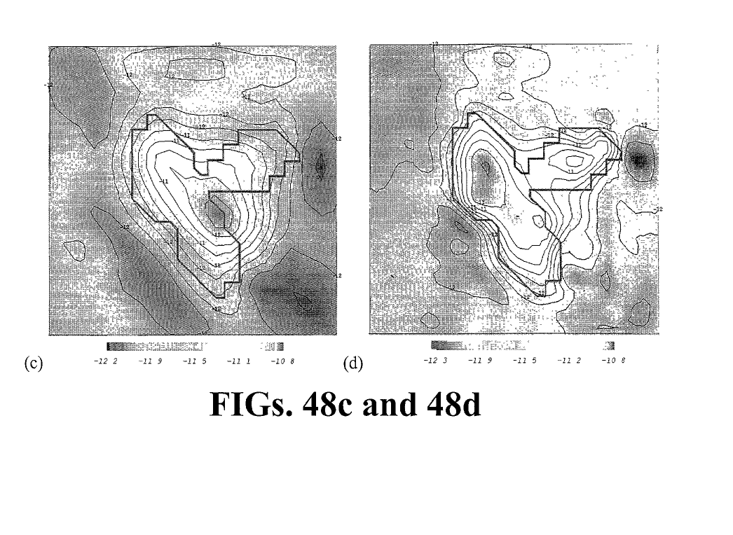

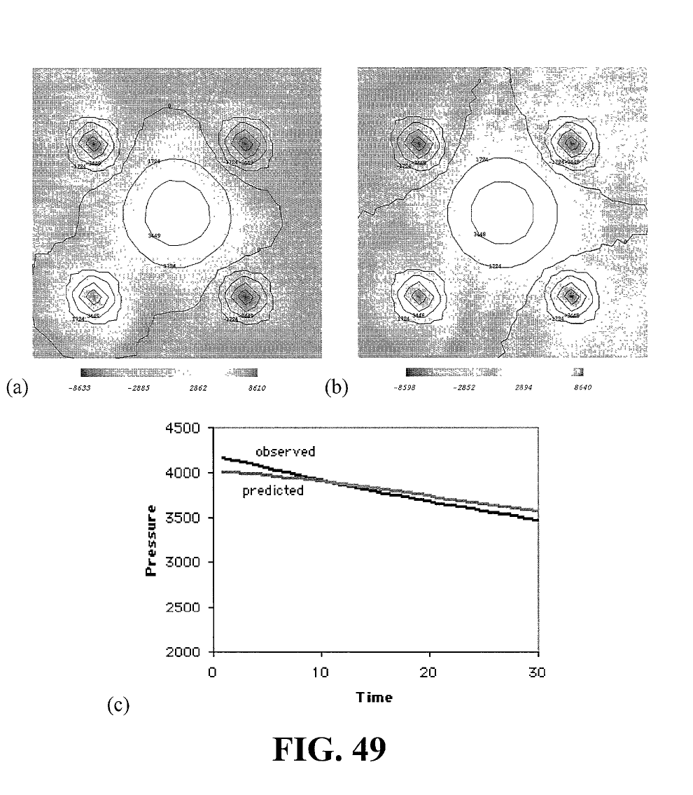

FDM is a viable technology. FIG. 48 shows a 2-D FDM test case domain (10×10 km). The pressure monitoring wells are shown with dots in FIG. 48a. This example demonstrates the multiple gridding approach. First a coarse permeability field is obtained and used as an initial guess for a finer resolved permeability field. This process reduces the computational effort to arrive at the most probable permeability field since it takes only a few iterations to solve the coarsely resolved problem. FIG. 40 shows another 2-D example where only two permeability logs are available. Although both permeability logs miss the puncture in the center, the FDM approach results in lower permeability at both ends of the domain and higher permeability in the center. This example demonstrates that the core and well log data can be directly imposed in the most probable reservoir state in the FDM approach, making FDM cost effective. As seen in FIG. 49, the FDM approach can also successfully predict the initial pressure distribution showing that production history and other dynamic data can be used to reconstruct the reservoir state. FIG. 42 shows that the methodology works well in 3-D. As in FIG. 48, even a crude discretization captures the overall reservoir shape. FIG. 29 shows an application for a case wherein the geometry of the Super-K zone is constrained to be circular and the information theory is used to determine the permeability and radius of this circular zone only. This shows that when only a simplified picture of the reservoir is adequate, the computations are very rapid and that the fall information theory, notably the explicit construction of the probability, can be carried out.

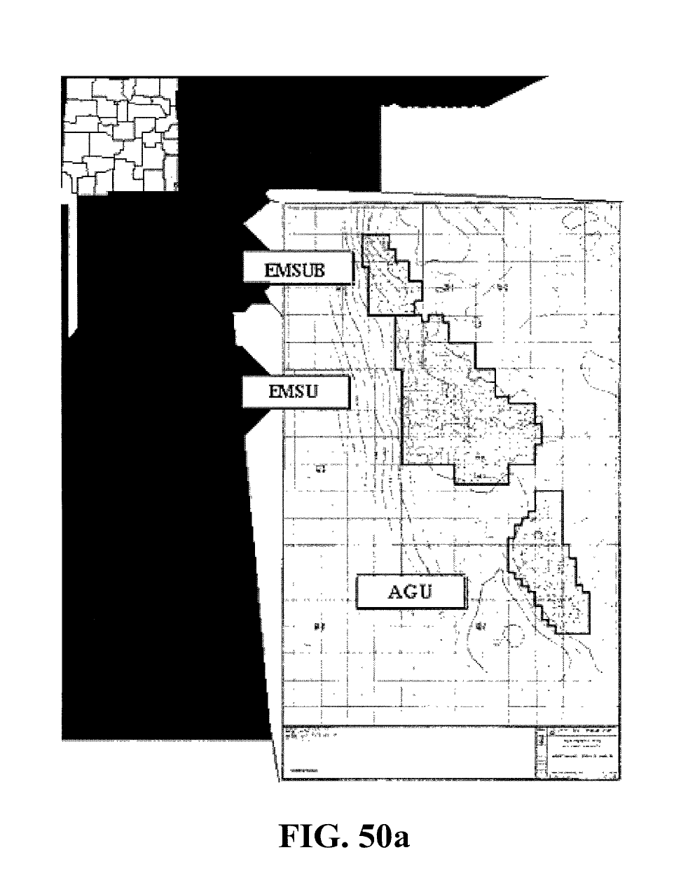

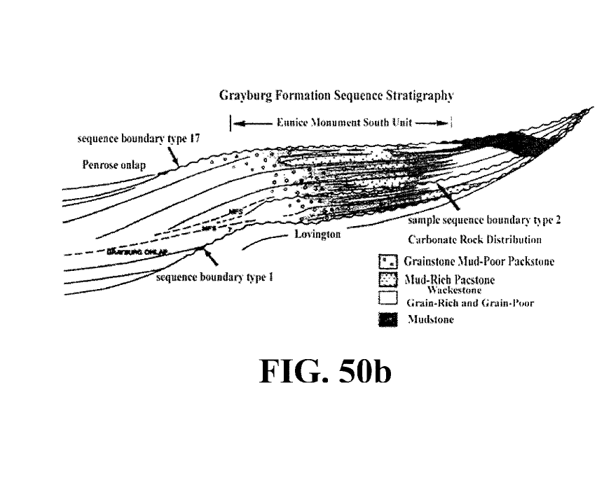

FDM is demonstrated in a waterflood Permian Basin unit (see FIG. 50). There is an excellent opportunity to ground-truth FDM because 75 to 100 infill wells will be drilled over the next four years, as well as 75 to 100 conversions to injection for pattern re-alignment. FDM is demonstrated using several reservoir simulators. The FDM software is written in a general style so that it can use well established reservoir simulators and multi-process advanced research simulators (such as Reservoir RTM and Basin RTM). FDM can simultaneously run multiple simulators to incorporate a wide variety of processes as required to predict a complete set of reservoir state variables.

Having shown the viability of FDM, FDM is demonstrated in an active field. The particular demonstration site (see FIG. 50) was chosen for the following reasons:

the availability of ample data;

the presence of a multi-lobed, compartmented reservoir;

the petroleum reservoirs and compartments are already identified;

its acknowledged potential for remaining reserves; and

the availability of earlier history matching studies for comparison.

The FDM technology to be demonstrated in this project has several unique features:

an industry-standard multi-phase reservoir simulator serves as a basis of comparison for other simulators to be used with FDM;

its reservoir simulators are the only ones available with full 3-D implementation and a comprehensive set of coupled RTM processes needed to realize the full benefits of the FDM integration of seismic, well log, and other data;

the new multi-phase flow model that accounts for dynamical changes in the identity of the wetting phase and important interfacial effects not captured by other multi-phase flow models;

a built-in capability to calibrate the physical models for the lithologies of interest;

advanced formulas for creating the synthetic seismic, log, and other data from the variables predicted by the reservoir simulators;

differences between predictions and actual data are used to create the objective by function;

the risk assessment technology accounts for the possibility of large uncertainties not captured in current geostatistics approaches; and

FDM computational algorithms that make extensive risk analysis computations feasible on available hardware.

The FDM software thus constitutes a major advancement in field development and management.

Establishing a steady, long-lasting, clean petroleum supply is key to the economy of the United States. FDM provides three approaches to achieving this goal through exploration and production technologies based on the computer automated use of well log, seismic, production history, and other data:

Improve the prediction of reservoir location and characteristics to lower exploration costs.

Identify compartments and, thereby, locate by-passed resources.

Make use of the billions of dollars of well log, seismic, production history, and geochemical data on U.S. basins which are presently under-used due to the cost of labor-intensive and often unreliable methods for interpreting them.

The economic value of FDM can be estimated as follows.

(1) The amount of petroleum remaining to be discovered is estimated to be 72% of estimated ultimate recovery for the U.S. and 93% worldwide. If FDM reduces the cost of finding and producing these reserves and thereby increases the producible fraction of this reserve by 10%, this yields a value of over one trillion dollars for the U.S. and 16 trillion dollars worldwide at today's prices.

(2) A conventional suite of logs costs $1 per foot. Assuming there are about 6 million logs averaging 5,000 feet available today on U.S. basins and that FDM ultimately makes use of 20% of these logs which would have otherwise gone unused or would have to be taken anew, this implies a savings of 6 billion dollars. Similar numbers could easily follow for seismic data.

(3) FDM saves investment by more judicious choice of exploration well siting. To meet projected demands for petroleum, 800,000 exploration wells will be drilled in the next 15 years. Assuming ¼ will be deep wells (>16,000 ft) drilled at an average cost of 1 million dollars and ½ of these will be completed at an additional cost of 1 million dollars each, a 10% improvement in well citing efficiency and log costs would net an investment savings of 32 billion dollars for that period.

(4) It is estimated that exploration in the next 15 years could cost 1.250 trillion dollars in the U.S. and much more outside the U.S. If the methods developed here could save 10% of this, this is a savings of 65 billion dollars in the U.S. over the next 15 years. In summary, the total estimated savings for oil and gas exploration in the U.S. that would follow from FDM would be 130 billion dollars and the total increased value from new reserves would be 1.4 trillion dollars in the next 15 years. Also, the new production expected at the projected rate of consumption by 2015, this additional U.S. reserve alone could support domestic petroleum consumption for 7.5 years, adding stability to our economy.

In addition to these overall U.S. and worldwide economic benefits, the Permian Basin of Texas and New Mexico have great prospectives for future reserves. The Permian Basin has been chosen to demonstrate the FDM technology. The data indicate that there is great future potential for finding and producing significant new reserves. The demonstration provides specific guidelines on Permian Basin future development and on the extrapolation of the results to other U.S. basins.

Through its automated use of measured data (as in FIGS. 46 and 47), FDM greatly increases the producible U.S. reserves. As the technology predicts both reservoir quality, geometry, and location, it greatly improves the economics of production and minimizes loss from by-passed oil and gas.

Being able to model the original and present-day state of compartments to avoid by-passing petroleum is a key strength of the FDM approach. Sedimentary basins and reservoirs are typically divided into a mosaic of compartments whose internal fluid pressures can be over (OP) or under (UP) hydrostatic pressure. Each compartment is surrounded by a seal (an envelope of very low permeability rock). The Anadarko Basin is a highly compartmented system, as seen in FIG. 22. Compartments are common features across the U.S. (see FIG. 44). Identifying compartments is key to locating by-passed petroleum in mature fields. Extensive interest in these phenomena has been generated in modeling them because of their role as petroleum reservoirs.

Compartmentation can occur below a certain depth due to the interplay of a number of geological processes (subsidence, sedimentation, and basement heat flux) and physico-chemical processes (diagenesis, compaction, fracturing, petroleum generation, and multi-phase flow).

The present basin model is a 3-D reaction, transport, and mechanical (RTM) simulator with the unique capability for predicting the location and characteristics of compartments of various types. FIGS. 7 and 8 show a simulated set of stacked compartments in the Piceance Basin (CO) whose internal hydrologic continuity is fracture-associated and interbed the fractured sandstones. FIG. 11 shows a subsalt compartment generated by compaction in a zone of lower fluid pressure and sustained porosity in an overpressured zone. In both these examples, petroleum generation plays a key role in the generation of overpressure and associated porosity/permeability preservation. No other basin model can make such predictions.

The present method incorporates a number of multi-phase and geomechanical simulators used individually or coupled to reservoir simulators to demonstrate FDM. Reservoir RTM and Basin RTM simulators are uniquely suited for the multi-data set FDM approach. It is the data set of texture (grain size, shape, and packing), fluid phase saturation, composition, stress, temperature, and fracturing used in creating the synthetic seismic, well log, and other data that gives FDM its great predictive power.

Numerical models of multi-phase flow in porous media have been developed by various researchers based on finite difference and finite element methods. These models focus on the surface spills and subsurface leakage of hydrocarbons from pipes and storage tanks and on reservoir simulation. Progress in the theory of multi-phase flow has been hampered by the absence of a complete set of variables describing pore-scale fluid configuration dynamics. The present method incorporates improved multi-phase flow laws and models parameters by the introduction of wetting fraction (fractions of the pore surface wetted with each fluid phase) dynamics (see FIG. 35).

The geometry of the fluid phases (FIG. 33) changes due to the overall flow-through and the latter affects the geometry of the phases. The omission of this geometry to flow coupling is a fundamental weakness of existing models. A phase geometry dynamics model addresses this problem. The fluids within a pore are described by their saturations s(={s₁,s₂,Λ sₚ}) for the N₉₂ phase system and a set of variables ξ(=ξ₁,ξ₂, Λ ξ_{N}_{_{g}}) of the N_{g} geometry variables describing the fraction of the solid matrix surface wetted with the various phases.

$$\frac{ⅅ {ξ}_{i}}{ⅅ t} = {G}_{i} ( ξ , s , c , Θ , T ) \qquad ( 5 )$$

where c is a set of concentrations describing the composition of each of the fluid phases and Θ characterizes the size, shape, and packing of the grains of each mineral.

The flow law is developed as a balance of forces:

$${η}_{i} φ {s}_{i} {\sum }_{j = 0}^{{N}_{p}} {Δ}_{ij} ( {\underline{v}}_{j} - {\underline{v}}_{i} ) - {\sum }_{j = 0}^{{N}_{p}} {K}_{ij} ( \underline{∇} {p}_{i} + {\underline{Γ}}_{ij} + {ρ}_{i} \underline{g} ) = \underline{0} , \qquad ( 6 )$$

where the Γ, K, and Δ parameters depend on wetting, saturation, and composition of the phases; ρⱼ is the mass density of phase j while g is the gravitational acceleration vector.

With this model, it is clear wherein the hysteresis lies. In principle, one can solve equation (5) for the ξᵢ as functionals of s,c,T for all times t′<t for the time t of interest. Thus, if not accounting for the geometry variables, then the A, r, K parameters depend, through the ξ, on the prior history of s,c,T, i.e., on the hysteresis effect.

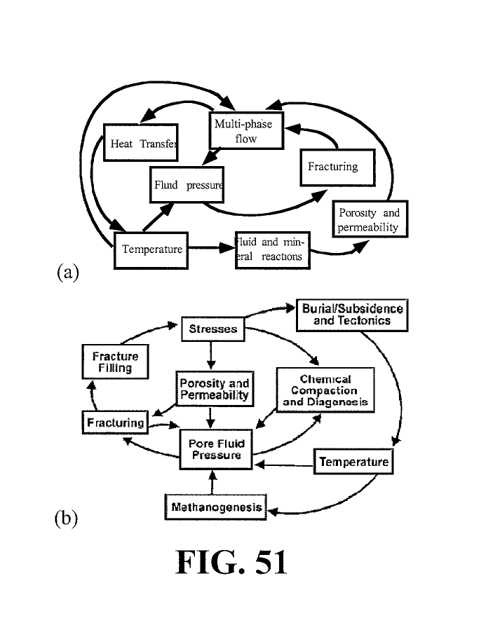

A complex network of geochemical reactions, fluid and energy transport, and rock mechanical processes underlies the dynamics of a reservoir or sedimentary basin (see FIG. 51). Therefore, prediction of reservoir location and characteristics lies outside the realm of simple approaches. Basin RTM accounts for most of the geological factors and RTM processes presently believed to be important for understanding a dynamic petroleum system. As reservoirs are fundamentally 3-D in nature, the simulator is fully 3-D. To date, no other basin simulator has this level of completeness, solves all RTM equations in 3-D based on finite element methods, and preserves all coupling relations as in FIG. 51. The RTM processes and geological factors accounted for in Basin RTM are outlined in FIG. 51. External influences such as sedimentation/erosion, sea level, basement heat flux, and overall tectonic histories are allowed to influence the internal RTM processes through their effects at a basin's boundaries. The RTM processes modify the sediment chemically and mechanically within a basin to produce faults, petroleum reservoirs, and other features.

The following features show the comprehensiveness of the rock/fluid state description and the completeness of the set of chemical and physical processes evolving them. This richness makes it possible for FDM to integrate well log, seismic, production history, and pressure data with reservoir simulation.

Incremental stress rheology is used to integrate poroelasticity, viscous flow with yield behavior, fracturing, and pressure solution. In most studies sediments are considered as either nonlinear Newtonian fluids or as elastic media, thereby ignoring the effects of faulting and fracturing (see FIGS. 7, 8, and 44).

Faulting occurs via a Drüker-Prager criterion to signal failure, and a texture dynamics model is used to compute the evolving, associated rheologic properties.

Petroleum generation/rock deformation and multi-phase flow are solved simultaneously to capture seals, abnormally pressured compartments, and petroleum expulsion (FIG. 11).

Inorganic and organic solid state and fluid reactions and their temperature and ionic state dependencies are accounted for.

As are grain growth/dissolution, breaking of grain-grain contacts, pressure solution and gouge evolve rock texture.

A 3-D computational platform is used. All other basin simulators are limited to 2-D or a few processes. Nonlinear dynamical systems have a strong dependence on spatial dimensionality. Therefore, a 3-D computational platform is preferred to gain a better understanding of fracture networks and reservoirs and the dynamical petroleum system (FIGS. 7 and 8).

A 3-D fracture network dynamics has been developed that accounts for the stress tensor, fluid pressure, and rock texture variables.

Minor additions to FDM facilitate the input of multiple data types (seismic, well logs, production history) or data sets of varying quality (e.g., old versus modern seismic data). Formulas are added for the synthetic well logs (FIG. 26) and for relating seismic wave speed to fluid/rock state. Thus FDM overcomes difficulties with classic seismic data from the many factors affecting mechanical wave speed and attenuation including:

porosity and texture of unfractured rock;

density and phases of pore- and fracture-filling fluids;

fracture length and aperture statistics and connectivity;

fracture orientation relative to the propagation direction;

fracture cement infilling volume, mineralogy, and texture;

pressure and temperature; and

gouge layers.

This many variables cannot be extracted from the speed and attenuation of reflected or transmitted seismic waves, even when the various polarizations and shear vs. compression components are separately monitored. Thus, direct remote detection cannot provide enough information to unambiguously identify and characterize reservoirs. This is not a difficulty for FDM, however.

FDM uses several reservoir simulators based on the algorithms of FIGS. 46 and 47. This probes the viability and sensitivity of the FDM method for the types of reservoir models presently used. Types of simulators include:

2- and 3-phase black oil models;

compositional multi-phase models;

dual porosity/dual permeability flow models;

comprehensive RTM models; and

next generation multi-phase flow models including the phase geometry dynamics.

These models are fully implemented.

FDM is demonstrated on a Permian Basin field in New Mexico. This field contains complex reservoirs and thus presents a challenge for FDM. Predictions based on various combinations of production history, seismic, well log, and other data sets are used via FDM to determine the most cost-effective data mix for achieving reliable predictions. FDM predictions are compared with

recently acquired 3-D seismic and other data;

a picture of the reservoirs based on extensive geological, geophysical, and production analysis; and

results of history matching.

To demonstrate production optimization in New Mexico Permian Basin:

(1) select a time in the past and define it to be time zero;

(2) make FDM predictions of the most probable state at time zero;

(3) use (2) to predict the production from time zero to the present and compare results with the observed history;

(4) make a determination using the FDM approach of a more optimal production scenario and compare it with that which took place; and

(5) estimate by-passed petroleum captured via the FDM-assisted production strategy.

A second series of tests determines the best mix of data for optimizing the accuracy of FDM predictions. This produces guidelines on the types (seismic, well logs, production history) and input data accuracy that give the most information with the least cost. Similar tests are made regarding the optimum density of geographic and depth data coverage.

To evaluate the success of the FDM demonstration and FDM's potential economic impact, FDM predictions are compared with more classical techniques including:

presently-used history matching,

cross-well tomography, and

geostatistics.

The quantitative measures of success or failure include differences in the FDM and classical methods with respect to:

accuracy of the predicted reservoir state;

the effort and cost required to generate the prediction;

the level of useful detail in the prediction;

the range of the situations in which the technology can be used;

the potential for future improvement of the technology; and

the cost savings that could accrue for the technology.

The key limitations to the present ability to more cost-effectively develop and produce a field are the uncertain characterization of the preproduction state of a field and the need for a next generation of reservoir simulations with improved multi-phase flow and other processes. The FDM software achieves unprecedented efficiency in predicting the most probable preproduction state and, to assess economic risk, the uncertainty in this delineation. By bringing both a well-tested reservoir simulator and a new fluid phase geometry and coupled multi-phase flow/rock deformation-fracturing simulators, FDM addresses the need for advanced reservoir simulation tools. With this improved ability to automatically characterize a field or reservoir, FDM technology greatly decreases losses from by-passed reserves or reservoir damage. FDM technology and next generation reservoir simulators enable the industry to more accurately formulate optimal production strategies and assess associated risk in each strategy.

### Probability Functionals, Homogenization, and Comprehensive Reservoir Simulators

A probability functional method is used to determine the most probable state of a reservoir or other subsurface features. The method is generalized to arrive at a self-consistent accounting of the multiple spatial scales involved by unifying information and homogenization theories. It is known that to take full advantage of the approach (e.g., to predict the spatial distribution of permeability, porosity, multi-phase flow parameters, stress, fracturing) one should embed multiple reaction, transport, mechanical process simulators in the computation. A numerical technique is introduced to directly solve the inverse problem for the most probable distribution of reservoir state variables. The method is applied to several two- and three-dimensional reservoir delineation problems.

The state of a reservoir or other subsurface feature is generally only known at selected space-time points on a rather coarse scale. Yet it would be desirable to reconstruct the spatial distribution of fluid/rock state across a reservoir or other system. A probability functional formalism is used to determine such fluid/rock variables as functions of position because the subsurface can only be determined with great uncertainty, that is, the method analyzes the probability of a continuous infinity of variables needed to describe the distribution of properties across the system.

This is not readily accomplished without the use of models that describe many fluid/rock variables. For example, a classical history matching procedure using a single phase flow model could not be used to determine the preproduction oil saturation across a system. As a complete understanding of reservoir state involves the fluid saturations, nature of the wetting, porosity, grain size and mineralogy, stress, fracture network statistics, etc., it is clear that hydrologic simulators are needed that account for a full suite of reaction, transport, and mechanical processes. The present method is a probability functional-RTM reservoir simulator approach to the complete characterization of a subsurface system.

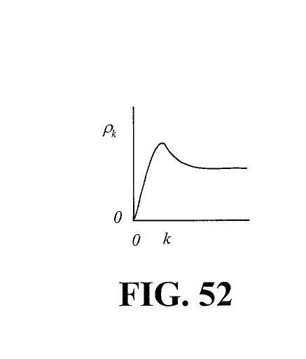

The state of a reservoir involves variations in space over a wide range of length scales. As suggested in FIG. 38, the shape and internal characteristics of a reservoir can vary on a wide range of scales including those shorter than the scale on which the observations could resolve. For example, knowing fluid pressure at wells separated by 1 km could not uniquely determine variations of permeability on the 10 cm scale. Therefore one considers the determination of the most probable state among the unrestricted class of states that can involve variations on all spatial scales. FIG. 52 suggests that the probability ρₖ of variations on a length scale 2π/k become independent of k as k→∞. Thus in a classic history matching approach, there is an uncountable infinity of solutions. The present approach seeks the most probable upscaled state consistent with the scale on which the observations are taken.

Let a reservoir be characterized by a set of variables Ψ [symbol] at all points [symbol] within the system at a given time. For example, Ψ [symbol] may represent the values of porosity, grain size and mineralogy, stress, fractures, petroleum vs. water saturation, and state of wetting before production began. The present method seeks the probability ρ[Ψ] that is a functional of Ψ and, in particular, constructs it to be consistent with a set of observations O(={O₁,O₂,Λ O_{N}}) at various points across the system or at various times. In addition, assume that an RTM reservoir simulator can compute these observables given an initial state Ψ [symbol] . Let Ω(={(Ω₁,Ω₂,Λ Ω_{N}}) be the set of computed values corresponding to O. Clearly, Ω is a functional of Ψ [symbol] . Information theory provides a prescription for computing probability. For the present problem, the prescription may be stated as follows. The entropy S is defined via

$$S = - {S}_{Ψ} ρλ n ρ \qquad ( II .1 )$$

where S indicates a functional integral. Normalization implies

$${S}_{Ψ} ρ = 1. \qquad ( II .2 )$$

The entropy is to be maximized subject to a set of constraints from the known information. Let C₁,C₂,Λ C_{Nc} be a set of constraints that depend on O and Ω and, therefore, are functionals of Ψ. Introduce two types of constraints. One group, the “error constraints,” are constructed to increase monotonically with the discrepancy between O and Ω. A second group places bounds on the spatial resolution (the length scale) over which the method seeks to delineate the reservoir attributes. These constraints are required for self-consistency as the reservoir simulators typically used assume a degree of upscaling imposed by a lack of short scale information and practical limits to CPU time. The constraints are functionals of Ψ(C=C[Ψ]). Impose the “information”

$${S}_{Ψ} ρ {C}_{i} = {Γ}_{i} , i = 1 , 2 , Λ {N}_{c} . \qquad ( II .3 )$$

Using the Lagrange multiplier method, obtain maximum entropy consistent with equations (II. 2,3) in the form

$$\begin{matrix}λ n ρ = - λ n Ξ - {\sum }_{i = 1}^{{N}_{c}} {β}_{i} {C}_{i} [ Ψ ] & ( II .4 ) \\ Ξ = {S}_{Ψ} exp [ {\sum }_{i = 1}^{{N}_{c}} {β}_{i} {C}_{i} ] . & ( II .5 )\end{matrix}$$

The βs are Lagrange multipliers and [symbol] is the normalization constant.

In the present approach, focus on the most probable state Ψ^{m}. The maximum in ρ occurs when

$${\sum }_{i = 1}^{{N}_{c}} {β}_{1} \frac{δ {C}_{i}}{δ {Ψ}_{a} {( r )}^{M}} = 0.$$

Here δ/δΨ_{α} indicates a functional derivative with respect to the α-th fluid/rock state variable. The present method solves these functional differential equations for the spatial distribution of the N reservoir attributes Ψᵢ^{m} [symbol] ,Ψ₂^{m} [symbol] ,Λ Ψ_{N}^{m} [symbol] .

There are two sets of conditions necessary for the solution of equation (II.5). The character of the homogenization constraints is that they only have an appreciable contribution when Vf has spatial variations on a length scale smaller than that assumed to have been averaged out in the upscaling underlying the RTM reservoir models used to construct the Ψ-dependence of the d?.

The functional dependence of the predicted values Ω[Ψ] on the spatial distribution of reservoir state Ψz,13 is determined by the laws of physics and chemistry that evolve the “fundamental” fluid/rock state variables Ψ. These fundamental variables to include

stress;

fluid composition, phases, and their intra-pore scale configuration (e.g., wetting, droplet, or supra-pore scale continuous phase);

grain size, shape, packing, and mineralogy and their statistical distribution;

fracture network statistics; and

temperature.

With these variables, the method predicts the derivative quantities (e.g., phenomenological parameters for the RTM process laws):

permeability;

relative permeabilities, capillary pressure, and other multi-phase parameters;

rock Theological parameters; and

thermal conductivity.

From the last one, one can, through the solution of reservoir RTM equations, determine the functionals Ω[Ψ]. Thus Ψ is considered to be the set of fundamental variables at some reference time (e.g., just prior to petroleum production or pollutant migration). The dependence of Ω on Ψ comes from the solution of RTM equations and the use of phenomenological laws relating the derived quantities to the fundamental ones.

This approach uses information theory to provide a mathematical framework for assessing risk. Information theory software is used to integrate quantitative reservoir simulators with the available field data. The approach allows one to:

use field data of various types and quality;

integrate the latest advances in reservoir or basin modeling/simulation into production planning and reserve assessment;

predict the quantitative state (distribution of porosity, permeability, stress, reserves in place) across the system;

place quantitative bounds on all uncertainties involved in our predictions/strategies; and

carry out all the above in one automated procedure.

This technology improves the industry's ability to develop known fields and identify new ones by use of all the available seismic, well log, production history, and other observation data.

The present method is a self consistent method for finding the most probable homogenized solution by integrating multiple scale analysis and information theory. The self consistency is in terms of level of upscaling in the reservoir simulator used and the spatial scale to which one would like to resolve the features of interest. Furthermore, the homogenization removes the great number of alternative solutions of the inverse problem which arise at scales less than that of the spatial resolution of data. The great potential of the method to delineate many fluid/rock properties across a reservoir is only attained through the use of multiple RTM process simulators. The present method is a major advance over presently used history matching algorithms due to self consistent treatment of multiple scales and direct approach to obtaining the most probable reservoir state. Finally, having embedded the computations in an overall context of information theory, the approach yields a practical method for assessing risk.

In view of the many possible embodiments to which the principles of this invention may be applied, it should be recognized that the embodiments described herein with respect to the drawing figures are meant to be illustrative only and should not be taken as limiting the scope of invention. Therefore, the invention as described herein contemplates all such embodiments as may come within the scope of the following claims and equivalents thereof.

We claim:

1. A method for producing a three-dimensional map of fracture locations and characteristics in a geological basin, the method comprising:
collecting data pertaining to characteristics of the geologic basin;
simulating rock rheology by integrating continuous deformation with fracture, fault, gouge, and pressure solutions;
simulating mechanical processes to coevolve deformation with multi-phase flow, petroleum generation, mineral reactions, and heat transfer to predict the location and producibility of fracture sweetspots;
adjusting the predictions to reduce their deviation from the collected data; and
integrating the resulting predictions with the collected data to construct maps of high-grading zones of fracture producibility.

2. The method of claim 1 wherein collecting data includes collecting data in the set: well log data, surface data, core data, seismic data.

3. A computer-readable medium having instructions for performing the method of claim 1.
